(19) United States
(12) Patent Application Publication
(10) Pub. No.: US 2026/0080038 A1
(43) Pub. Date: Mar. 19, 2026

(54) ACCELERATED GENERATION OF WATERMARKED CONTENT IN LARGE LANGUAGE MODELS

(71) Applicant: UNIVERSITY OF MARYLAND, COLLEGE PARK, College Park, MD (US)

(72) Inventors: Zhengmian HU, College Park, MD (US); Heng HUANG, Potomac, MD (US)

(21) Appl. No.: 19/342,307

(22) Filed: Sep. 26, 2025

Related U.S. Application Data
(63) Continuation-in-part of application No. 19/329,343, filed on Sep. 15, 2025.
(60) Provisional application No. 63/694,907, filed on Sep. 15, 2024.
(60) Provisional application No. 63/699,748, filed on Sep. 26, 2024.

(51) Int. Cl. G06F 21/16; G06F 40/40

(52) U.S. Cl. CPC G06F 21/16; G06F 40/40

(57) ABSTRACT

A method may include inputting, into a draft model, a sequence of tokens conditioned on a given first context to obtain an original draft distribution of draft tokens. The method may also include applying, based on a watermark code, a reweight function to adjust probabilities of the original draft distribution to generate a watermarked draft distribution of watermarked draft tokens. The method may further include inputting, into a target model, watermarked draft tokens and a sequence of tokens conditioned on a given second context to obtain an original target distribution. In addition, the method may include applying, based on the watermark code, the reweight function to probabilities of the original target distribution to generate a watermarked target distribution of watermarked target tokens. The method may further include sampling a watermarked output from the watermarked draft distribution or the watermarked target distribution based on the adjusted probabilities.

### CROSS-REFERENCE TO RELATED APPLICATIONS

This application is a continuation-in-part of U.S. non-provisional patent application Ser. No. 19/329,343, filed on Sep. 15, 2025, which in turn claims the benefit of U.S. provisional patent application No. 63/694,907, filed on Sep. 15, 2025. This application also claims priority from U.S. provisional patent application No. 63/699,748 filed on Sep. 26, 2024. The contents of these earlier filed applications are hereby incorporated by reference in their entirety.

### FIELD

Some embodiments may generally relate to watermarking. For example, certain example embodiments may relate to apparatuses, systems, and/or methods for providing accelerated generation of watermarked content in large language models (LLM).

### BACKGROUND

Large language models (LLMs) have advanced to the point where they can generate text that is nearly indistinguishable from human writing, which poses significant challenges in preventing the dissemination of malicious content and controlling the spread of synthetic data. This raises concerns about misuse for activities such as, for example, disinformation campaigns, spam, or fraudulent communications.

One approach to mitigate the risks in LLMs is to incorporate watermarking techniques into LLMs, allowing for the tracking and attribution of model outputs. Existing watermarking techniques inject watermarks into the generated content without altering the output quality. On the other hand, existing acceleration techniques such as, for example speculative sampling, leverage a draft model to speed up the sampling process while preserving the output distribution. However, there is no known method to simultaneously accelerate the sampling process and inject watermarks into the generated content. Thus, there is a need for techniques that provide a foundation for understanding the inherent trade-off between watermark strength and sampling efficiency in accelerating the generation of watermarked tokens for LLMs.

### SUMMARY

Some embodiments may be directed to a method. The method may include inputting, into a draft model, a sequence of tokens conditioned on a given first context to obtain an original draft distribution of draft tokens. The method may also include applying, based on a watermark code, a reweight function to adjust probabilities of the original draft distribution to generate a watermarked draft distribution of watermarked draft tokens. The method may further include inputting, into a target model, watermarked draft tokens and a sequence of tokens conditioned on a given second context to obtain an original target distribution. In addition, the method may include applying, based on the watermark code, the reweight function to adjust probabilities of the original target distribution to generate a watermarked target distribution of watermarked target tokens. Further, the method may include sampling a watermarked output from the watermarked draft distribution or the watermarked target distribution based on the adjusted probabilities.

Other embodiments may be directed to an apparatus. The apparatus may include at least one processor and at least one memory including computer program code. The at least one memory and computer program code may be configured to cause the apparatus at least to, input, into a draft model, a sequence of tokens conditioned on a given first context to obtain an original draft distribution of draft tokens. The apparatus may also be caused to apply, based on a watermark code, a reweight function to adjust probabilities of the original draft distribution to generate a watermarked draft distribution of watermarked draft tokens. The apparatus may further be caused to input, into a target model, watermarked draft tokens and a sequence of tokens conditioned on a given second context to obtain an original target distribution. In addition, the apparatus may be caused to apply, based on the watermark code, the reweight function to adjust probabilities of the original target distribution to generate a watermarked target distribution of watermarked target tokens. Further, the apparatus may be caused to sample a watermarked output from the watermarked draft distribution or the watermarked target distribution based on the adjusted probabilities.

Other embodiments may be directed to an apparatus. The apparatus may include means for inputting, into a draft model, a sequence of tokens conditioned on a given first context to obtain an original draft distribution of draft tokens. The apparatus may also include means for applying, based on a watermark code, a reweight function to adjust probabilities of the original draft distribution to generate a watermarked draft distribution of watermarked draft tokens. The apparatus may further include means for inputting, into a target model, watermarked draft tokens and a sequence of tokens conditioned on a given second context to obtain an original target distribution. In addition, the apparatus may include means for applying, based on the watermark code the reweight function to adjust probabilities of the original target distribution to generate a watermarked target distribution of watermarked target tokens. Further, the apparatus may include means for sampling a watermarked output from the watermarked draft distribution or the watermarked target distribution based on the adjusted probabilities.

In accordance with other embodiments, a non-transitory computer readable medium may be encoded with instructions that may, when executed in hardware, perform a method. The method may include inputting, into a draft model, a sequence of tokens conditioned on a given first context to obtain an original draft distribution of draft tokens. The method may also include applying, based on a watermark code, a reweight function to adjust probabilities of the original draft distribution to generate a watermarked draft distribution of watermarked draft tokens. The method may further include inputting, into a target model, watermarked draft tokens and a sequence of tokens conditioned on a given second context to obtain an original target distribution. In addition, the method may include applying, based on the watermark code, the reweight function to adjust probabilities of the original target distribution to generate a watermarked target distribution of watermarked target tokens. Further, the method may include sampling a watermarked output from the watermarked draft distribution or the watermarked target distribution based on the adjusted probabilities.

Other embodiments may be directed to a computer program product that performs a method. The method may include inputting, into a draft model, a sequence of tokens conditioned on a given first context to obtain an original draft distribution of draft tokens. The method may also include applying, based on a watermark code a reweight function to adjust probabilities of the original draft distribution to generate a watermarked draft distribution of watermarked draft tokens. The method may further include inputting, into a target model, watermarked draft tokens and a sequence of tokens conditioned on a given second context to obtain an original target distribution. In addition, the method may include applying, based on the watermark code, the reweight function to adjust probabilities of the original target distribution to generate a watermarked target distribution of watermarked target tokens. Further, the method may include sampling a watermarked output from the watermarked draft distribution or the watermarked target distribution based on the adjusted probabilities.

### BRIEF DESCRIPTION OF THE DRAWINGS

For proper understanding of example embodiments, reference should be made to the accompanying drawings, wherein:

FIG. 1 illustrates an example of unbiased reweighting, according to certain embodiments.

FIG. 2 illustrates an example of another unbiased reweighting, according to certain embodiments.

FIG. 3 illustrates an example watermarking flow, according to certain embodiments.

FIG. 4 illustrates an example watermarking framework, according to certain embodiments.

FIG. 5A illustrates an example distribution of perplexity of outputs for text summarization (TS) and bilingual evaluation understudy (BLEU) score for machine translation (MT), according to certain embodiments.

FIG. 5B illustrates an example of another distribution of perplexity of outputs for TS and BLEU score for machine translation (MT), according to certain embodiments.

FIG. 6 illustrates a table of performance results of different watermarking methods, according to certain embodiments.

FIG. 7 illustrates a table of a mean and variance score per token for different reweighting methods and different tasks, according to certain embodiments.

FIG. 8 illustrates an example comparative diagram of trade-offs between watermarking strength and speculative sampling efficiency, according to certain embodiments.

FIG. 9 illustrates an example algorithm for maintaining a watermark strength or maintaining a sampling efficiency, according to certain embodiments.

FIG. 10 illustrates results of a comparative analysis, according to certain embodiments.

FIG. 11 illustrates an example algorithm of basic sampling, according to certain embodiments.

FIG. 12 illustrates an example algorithm of vanilla speculative sampling (VSpS), according to certain embodiments.

FIG. 13 illustrates an example algorithm of vanilla unbiased watermarking (VUW), according to certain embodiments.

FIG. 14A illustrates an example table of raw data, according to certain embodiments.

FIG. 14B illustrates a continuation of the example table illustrated in FIG. 14A, according to certain embodiments.

FIG. 15 illustrates example results of a text summarization task, according to certain embodiments.

FIG. 16 illustrates example results of an open-ended text generation task, according to certain embodiments.

FIG. 17 illustrates example results of another open-ended text generation task, according to certain embodiments.

FIG. 18 illustrates an example token generation flow, according to certain embodiments.

FIG. 19 illustrates an example flow diagram of a method, according to certain embodiments.

FIG. 20 illustrates an apparatus, according to certain embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for providing accelerated generation of watermarked content in large language models (LLM).

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain embodiments, and not in limitation thereof.

LLMs have demonstrated remarkable performance in various natural language processing tasks, enabling a wide range of applications such as chatbots, content generation, code generation, and more. However, the high training and inference costs of LLMs pose significant challenges, and the substantial computational resources along with the high latency during inference may negatively impact user experience and limit their potential applications. Thus, to address these issues, speculative sampling has provided a way to leverage a smaller, faster draft model to generate candidate results, which are then validated and corrected by a larger, more accurate target model. The draft model may be similar to the target model in that they are both functions. For example, given an input prefix (e.g., token sequence), the draft model may output a probability distribution over the entire vocabulary. However, the draft model may typically be smaller and faster than the target model. Similarly for the target model, given an input prefix (e.g., token sequence), it may output a probability distribution over the entire vocabulary. Compared with other acceleration methods such as distillation, model quantization, and model pruning, speculative sampling can be advantageous by reducing inference latency without compromising the quality of the generated content.

In addition to the challenge of high inference costs, protecting the intellectual property rights of LLMs generated content has become increasingly important. Digital watermarking techniques have been implemented to embed watermark information into the generated content, enabling the tracking of model usage. Unbiased watermarking schemes have been developed to ensure that the watermarking process does not affect the quality of the generated content.

In view of the challenges exhibited from increased computation resources and high latency, certain embodiments may leverage speculative sampling to accelerate the generation of watermarked content. For example, certain embodiments may provide a two reweight framework, which allows for the integration of unbiased watermarking and speculative sampling techniques while guaranteeing an unchanged output distribution. For instance, certain embodiments may provide a framework that lies in the simultaneous reweighting of both the target model and the draft model, which improves the sampling efficiency compared to applying speculative sampling to a watermarked target model.

According to certain embodiments, providing watermarking as an unbiased watermark may make it nearly impossible for users to discern whether a service provider (e.g., organization or platform providing the LLM and/or related services) has incorporated watermarks or not. Furthermore, the presence of watermarks does not compromise the performance of the model in downstream tasks, ensuring that the overall utility of the language model is preserved. Certain embodiments therefore contribute to the ongoing interest around responsible AI development, suggesting that unbiased watermarks may serve as an effective means of tracking and attributing model outputs without sacrificing output quality.

Watermarking techniques can serve multiple purposes, such as embedding ownership information within the generated text to protect the intellectual property rights of the model. It can also help mitigate potential harm caused by LLMs by monitoring where the model is being used and whether it is being misused or abused.

A good watermarking method should not adversely affect the normal usage of the language model or degrade the quality of the generated text. However, sometimes there may be some trade-off between the strength of the watermark and the quality of the output text. For instance, in a method that augments the logits of a randomly selected set of “green” tokens (e.g., preferred or promoted tokens), by tuning the “magnitude of logits adjustment”, there may be a trade-off between watermark strength and text quality. The “green” tokens may be computed by randomly splitting the full vocabulary into “green” (promoted) and “red” (suppressed) lists. The split is deterministic but context-dependent, controlled by a random seed derived from the input context and a secret watermark key.

Certain embodiments show that with the right implementation, watermarking can be accomplished without affecting the output quality. This particular type of watermark may be referred to as an unbiased watermark. In certain embodiments, if the watermark causes a decline in output quality, there may be a method to detect the presence of the watermark based on the quality. Conversely, if the watermark cannot be detected, it implies that the output quality remains unaffected. A watermark is undetectable if one (without the watermark key) cannot distinguish between outputs from two services: one applying the watermark, and one that does not apply the watermark. Specifically, given a black-box access to one randomly selected service (watermarked or non-watermarked), and no knowledge of the watermark key, one would not be able to determine whether the watermark is present.

According to certain embodiments, an undetectable watermark may be unbiased. For instance, if a watermark is biased, the degradation in text quality or the systematic preference for certain tokens would be observable, making the watermark detectable. However, if a watermark is unbiased, it preserves the original LLM's output distribution. Further, any detection function ‘is_watermarked=f(x)’ may have an identical average for watermarked and non-watermarked text. One would not be able to statistically differentiate between watermarked and non-watermarked text.

Certain embodiments may provide a proof that with a suitable implementation, watermarking does not affect the output probability distribution. This has significant implications, as users who do not have the private key are unable to discern whether a service provider has applied watermarking to the model. Furthermore, the addition of watermarking does not affect the performance of the generated text in any downstream tasks.

As described herein, certain embodiments introduce an unbiased watermark, a family of watermark methods that guarantee the non-degradation of text quality. Certain embodiments may also provide a comprehensive framework that facilitates the design and detection of unbiased watermarks. Additionally, certain embodiments provide various reweight techniques that demonstrate the ability to preserve output quality in machine translation and text summarization tasks. Certain embodiments may also provide a max/min variant of a log-likelihood ratio (LLR) to test for watermark detection. This detection method may come with theoretical guarantees, specifically an upper bound on type I error and, thus, enhancing the reliability of watermark detection in language models (LMs).

In the context of LLMs, Σ denotes a vocabulary set of text, which is a set of all possible units of text (e.g., whole words, parts of a word, or a character or punctuation mark) known as tokens that an LLM can generate in a single step. The set Σ* may be defined as a collection of all possible strings of any length including those of length zero.

An LLM may generate a sequence of tokens conditions on a given context (e.g., or prefix, refers to the complete, evolving input available to the model at a specific generation step). In a single step, the probability of generating the next token xₙ₊₁⊂Σ given the current context, x₁, x₂, . . . , xₙ, can be denoted as P_{M}(xₙ₊₁|x₁, x₂, . . . , xₙ). The LLM may operate in an autoregressive fashion where the joint probability of generating multiple tokens xₙ₊₁, . . . , xₙ₊ₘ may be written as:

$${P}_{M} ( {x}_{n + 1} , … , {x}_{n + m} \vert {x}_{1} , {x}_{2} , … , {x}_{n} ) = {\prod }_{i = 1}^{m} {P}_{M} ( {x}_{n + i} \vert {x}_{1} , {x}_{2} , … , {x}_{n} , {x}_{n + 1} , … , {x}_{n + i - 1} ) .$$

For simplicity, the following notation may be used: P_{M}(x_{n+1:n+m}-x_{1:n}), where x_{n+1:n+m}=(xₙ₊₁, . . . , xₙ₊ₘ)∈Σ*.

According to certain embodiments, an autoregressive model may generate text one token at a time. Starting from a prompt (e.g., initial, fixed input provided by the user to start generation), the autoregressive model may predict the next token, append that token to the prompt, and repeat the prediction on the extended prompt. For example, to produce the sentence “I like to eat apple for breakfast”, with the prompt “I like to eat”, the model may proceed in the following manner: (1) Predict “apple” from the prompt “I like to eat”; (2) Append “apple” to the new prompt “I like to eat apple”; (3) Predict “for” from the new prompt; (4) Append “for” to the new prompt “I like to eat apple for”; and (5) Predict “breakfast” from the new prompt. From this example, the final output is the concatenation of all generated tokens.

In certain embodiments, scoring of the tokens may be performed in an autoregressive manner. For example, when a detection score is computed autoregressively, the score for the full sentence may be obtained by summing the individual scores for each generated token conditioned on its own prefix. Using the above example, a score may first be determined for “apple” given the prefix “I like to eat”. Next, the score for “for” may be determined given the prefix “I like to eat”. Finally, the score for “breakfast” may be determined given the prefix “I like to eat apple for”. Thus, the final detection score for “I like to eat apple for breakfast” is the sum of the three token-level scores.

In the context of watermarking, a given private key k from a key space K. The key k E K may be selected at random from a prior distribution P_{K}(k). The watermarked output of the LLM may follow the distribution P_{M,w}(xₙ₊₁|x₁, x₂, . . . , xₙ;k), which is conditioned on both the key k and the context x_{1:n}. Similarly, the notation P_{M,w}(x_{n+1:n+m}|x_{1:n}; k) may be used for the probability of generating a sequence of tokens in a watermarked model.

According to certain example embodiments, a watermarking scheme may be efficiently detectable by a holder of the private key k, and the watermarking scheme cannot be detected by users while at the same time, does not negatively impact the quality of the output.

In certain embodiments, it may be possible to detect watermarks by users because it is closely related to the output quality. For example, if the watermark causes a degradation in the output quality, there may be a method to infer the presence of the watermark by examining the quality of the output. Conversely, if the watermark is undetectable, it may imply that the watermark does not impact the output quality.

A watermark may be considered undetectable if the probability distributions of the watermarked and non-watermarked outputs are identical. For example, probability distribution may refer to the complete set of likelihoods assigned to every possible output sequence (e.g., sentences) that a language model can generate for a given prompt. To capture this notion, several properties of watermarking schemes may be defined. For example, one watermarking scheme may include n-shot-undetectable scheme. In this scheme, for a fixed input sequence a∈Σ*, the watermarked LLM and the key prior pair (P_{M,w}, P_{K}) is n-shot-undetectable compared to the original LLM P_{M} if:

$${\prod }_{i = 1}^{n} {P}_{M} ( {x}^{i} \vert a ) = {\sum }_{k ∈ K} {P}_{K} ( k ) {\prod }_{i = 1}^{n} {P}_{M , w} ( {x}^{i} \vert a ; k ) ,$$

   |a; k), for any n number of strings xⁱ∈Σ*.

Another watermarking scheme may include a downstream-invariant where the watermarked LLM and key prior pair (P_{M,w}, P_{K}) are invariant compared to the original LLM P_{M} on downstream tasks if:

$${𝔼}_{x ∼ {P}_{M , w} ( \cdot \vert a ; k ) , k ∼ {P}_{K}} [ f ( x ) ] = {𝔼}_{x ∼ {P}_{M} ( \cdot \vert a )} [ f ( x ) ] ,$$

for any strings x, a∈Σ*, and for any metric ƒ:Σ*→ [symbol] .

According to certain embodiments, the one-shot-undetectable property implies the downstream invariant property, as identical distributions yield identical expectations for any function. This implication does not require the n-shot-undetectable property for n>1, which means a watermarking scheme that is one-shot-undetectable may still maintain the output quality for downstream tasks even if the user might discern the existence of the watermark through multiple generation requests.

In certain embodiments, the feasibility of undetectability of watermarking may be analyzed. As one example, a service provider that offers a random number in the set {0, 1}. A clean generation process may be represented as P_{M}(x)=½, ∀x∈{0,1}. It may be assumed that the key k belongs to the set {0, 1} and is selected with equal probability. With the watermark added, the probability of the new output may be expressed as: P_{M,w}(x|k)=δₖ(x).

According to certain embodiments, the one-shot-undetectable property may be represented as P_{M}(x)=Σ_{k∈K}P_{M,w}(x|k)P_{K}(k). Assuming that a user can only make a single request to the service, if the user is unaware of the key, the user will be unable to distinguish whether the received result is watermarked or not. Thus, in this scenario, the undetectability of the watermark is achieved.

Although it may be possible to achieve undetectability of the watermark, there is a gap between this example and the practical implementation of watermarking in LLMs. For example, the symbol set E in LLMs is far more complex than the binary set {0, 1}, and the probability distribution is not uniform. Additionally, the generation process in LLMs is autoregressive, which means that more than one symbol are generated iteratively. Furthermore, the above example does not satisfy the n-shot-undetectable property for n>1. In certain embodiments, the underlying principles of undetectability may remain constant, while their application may become more intricate in a more complex environment.

According to certain embodiments, watermarking may be applied with unbiased reweighting. For instance, a random watermark code E and a reweight function R_{E}:Δ_{Σ}→Δ_{Σ} may depend on the random watermark code E. The set of all possible probability distributions on the symbol set Σ is denoted as Δ_{Σ}, which forms a simplex. The reweighting function may be a tuple (ε, P_{E}, R) where ε is the watermark code space, P_{E} is a probability distribution on space ε, and R is a function R:ε×Δ_{Σ}→Δ_{Σ}. For a specific watermark code E∈ε, the partially evaluated reweighting function may be denoted as R_{E}:Δ_{Σ}→Δ_{Σ}.

In certain embodiments, given a random watermark code E, a reweighting function R_{E}:Δ_{Σ}→Δ_{Σ}, R is an unbiased reweighting function if and only if for all P∈Δ_{Σ}, [symbol] _{E}[R_{E}(P)]=P.

According to certain embodiments, several unbiased reweighting methods may be provided. For instance, in one example, the reweighting methods may include a δ-reweight where the watermark code space ε is the interval [0, 1], and P_{E} is the uniform probability on ε. Leveraging inverse transform sampling (generating a uniform [0,1] random variate ∪; RETURN←F⁻¹(U)) (see Devroye, Luc; “Non-Uniform Random Variate Generation”; Springer New York, 1986; the teachings of which are hereby incorporated by reference), it may be possible to sample from distribution P∈Δ_{Σ} using a uniformly distributed random number [0, 1]. Thus, it may be possible to obtain a mapping sampling: ε→Σ. The δ-reweight returns a delta distribution R_{E}(P)=δ_{sampling}_{_{P}}_{(E)}. According to some embodiments, while the reweighted distribution for each individual random event E is a delta distribution, the mean output token probabilities remain the original distribution P when considering the randomness of E.

The reweighting methods may also include a γ-reweight where ethe watermark code ε is the set of all bijective function between vocabularies in set Σ and a set of indices [|Σ|]={1, . . . , [Σ]}, where |Σ| is the size of vocabularies set Σ. Any watermark code E is an indexing function for vocabularies set Σ, and is also equivalent to a total order on Σ. In the γ-reweight function, P_{E} may be set as the uniform probability on ε, making it easy to sample a watermark code E by randomly shuffling the symbol list.

According to certain embodiments, it may be assumed that the original distribution is P_{T}(t)∈Δ_{Σ}, ∀t∈Σ. Given the watermark code E:Σ→[|E|], auxiliary functions F_{I}(i)=Σ_{t∈Σ}1(E(t)≤i)P_{T}(t), and F_{S}(s)=max(2s−1,0), F_{I},(i)=F_{S}(F_{I}(i)) may be constructed. The γ-reweight yields a new distribution P_{T},(t)=F_{I},(E(t))−F_{I},(E(t)−1).

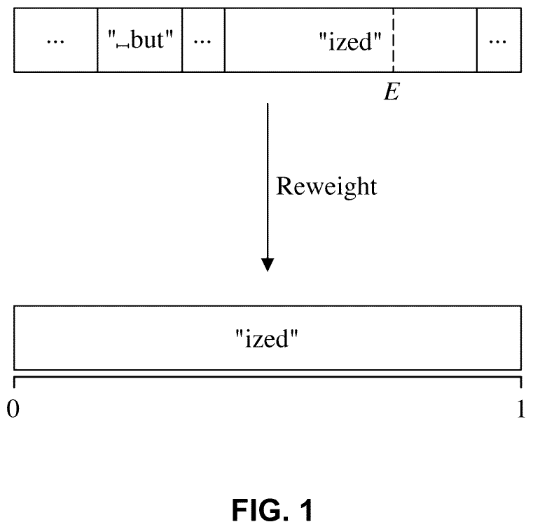

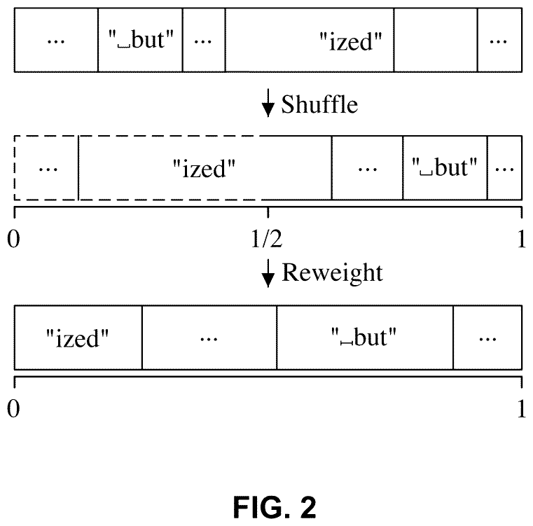

FIG. 1 illustrates an example δ-reweight method, according to certain embodiments, and FIG. 2 illustrates an example γ-reweight method, according to certain embodiments. As illustrated in FIGS. 1 and 2, each block represents a token, and the width of each block represents the probability of that token, which makes the total length 1. FIG. 1 illustrates the δ-reweight method where each individual random watermark code E∈[0,1] uniformly sampled from an interval of [0, 1] corresponds to a specific token according to the horizontal axis, and the reweighted distribution is just a δ distribution on that token such that the selected token has 1 probability, and all other vocabulary tokens have a probability of 0. FIG. 2 illustrates the γ-reweight method where ethe symbol set is shuffled, and then the left half of the regions are rejected. FIG. 2 also illustrates that the remaining regions are amplified with a factor of 2 (e.g., the token's generation probability may be altered—it may increase by as much as a factor of 2). In some embodiments, if the very first token in the reordered/shuffled symbol list carries more than ½ of the probability, no tokens are rejected, and the probably of that first token may be adjusted.

As illustrated in FIGS. 1 and 2, both methods are unbiased when considering the randomness of the watermark code E. For δ-reweight, since the probability of returning a δ distribution on a token is just the original probability on that token, the weighted average of all delta distributions is still the original probability. In the case of the γ-reweight, although certain regions are rejected and the other regions are amplified, every token has the same probability to be in the rejected or amplified region, thus ensuring the unbiased property.

In certain embodiments, reweighting may be provided for an autoregressive model. For instance, the reweighting methods may be applied to a single token-generation directly. Given a prefix x_{1:n}, the probability distribution for generating a new token without a watermark is denoted as P_{M}(⋅|x_{1:n})∈Δ_{Σ}. For a random watermark code E, a sample may be obtained from a new distribution P_{M,w}(⋅|x_{1:n})=R_{E}(P_{M}(⋅|x_{1:n})∈Δ_{Σ}. If the reweighting function is unbiased, the following may be obtained, [symbol] _{E}[R_{E}(P_{M}(⋅|x_{1:n}))]=P_{M}(⋅|x_{1:n}). This ensures that for an individual unaware of the watermark code, it is impossible to determine whether a new token is sampled directly from P_{M}(⋅|x_{1:n}) or from P_{M,w}(⋅|x_{1:n}; E) for a random watermark E. However, if the watermark code is known, one can perform statistical hypothesis testing to determine the likelihood of a token being sampled from either distribution. Since the LLM generation task is autoregressive, multiple reweighting steps may be required, with each step needing a watermark code Eᵢ for reweighting the distribution of token xᵢ.

In certain embodiments, Eᵢ values may be independent to ensure the unbiased nature of the entire sequence, rather than just the single-token generation process. Given an unbiased reweighting function (ε, P_{E}, R), if Eᵢ values are independent and identically distributed (i.d.d.) with the distribution P_{E}, the following is obtained: [symbol] _{E}_{₁}_{, . . . , E}_{ₙ}[P_{M,w}(x_{1:n}|a_{1:m})]=P_{M}(x_{1:n}/a_{1:m}). If the Et values are not independent, it may not be possible to guarantee that the generation probability of the entire sequence remains unbiased. For example, in a case where all Et values are identical, it may be assumed that the correct distribution is a sequence where each token is a random 0 or 1 with equal probability. Identical Et values would result in identical token outputs, ultimately producing sequences consisting solely of 0's or 1's, which is biased.

According to certain embodiments, a large number of independent watermark codes Eᵢ may be constructed during watermarking, and the watermark codes Eᵢ may be used during watermark detection by combining information from the prefix and a secret key to construct Eᵢ.

For a single token generation process, given a prefix x₁, x₂, . . . , xₙ, an abstract context code space C and an abstract context code generation function cc:Σ*→C may be considered. Based on the prefix, the context code cₙ₊₁=cc(x₁, x₂, . . . , xₙ) may be constructed. Examples may include using the entire prefix cₙ₊₁=(x₁, x₂, . . . , xₙ), and using the m most recent prefixes cₙ₊₁=(xₙ₋ₘ₊₁, . . . , xₙ). The framework of certain embodiments may accommodate diverse context code generation approaches, particularly those that integrate error-correcting mechanisms to augment watermark resilience in the face of text manipulation attacks. The final watermark code may be defined as Eᵢ=Ê(cᵢ, k), using a watermark code generation function Ê:C×K→ε.

According to certain embodiments, during insertion of the watermark, it may be possible to determine the context code c. The context may represent a string, and based on the string, it may be possible to extract a context code c. The context may refer to the portion of text that the learning model can see at the moment that the learning model predicts the next token. The context may represent the sequence of already-known characters, words, or sub-words that the learning model conditions on when generating the following output. Additionally, the context may supply the semantic, syntactic, and task-specific information that guides the learning model's prediction. The context may also be representative of the cumulative input (the original prompt plus any tokens the learning model has already emitted) that the learning model uses to determine what to output next. The context may further be the immediate textual environment that gives meaning to the upcoming token.

Given an unbiased reweighting function (ε, P_{E}, R) and a context code space C, an unbiased watermark code generation function may be a tuple (ε, P_{E}, R, C, K, P_{K}, Ê) that satisfies unbiasedness [symbol] _{k˜P}_{_{K}}[R_{Ê(c,k)}(P)]=P, ∀P∈Δ_{Σ}, ∀c∈C, and independence for any n distinct c₁, . . . , cₙ∈C, where the values R_{Ê(c}_{ᵢ}_{,k)}(P) are mutually independent.

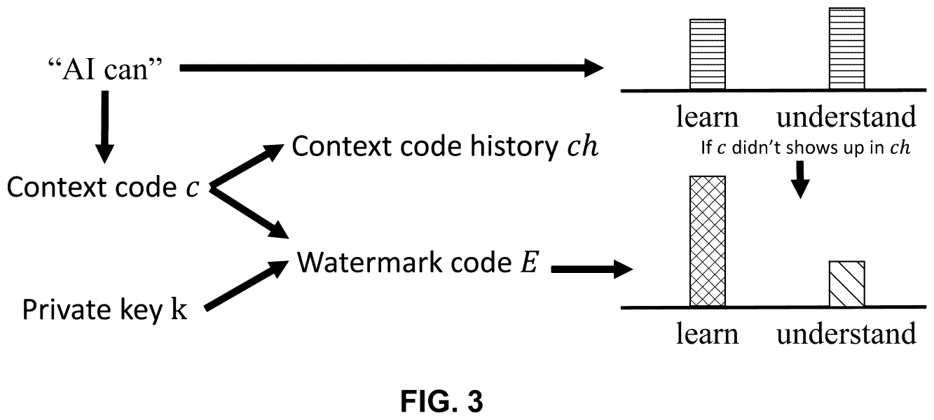

FIG. 3 illustrates an example watermarking flow, according to certain embodiments. As illustrated in FIG. 3, an input “AI can” may be added to a learning model such as, for example, an LLM. Upon receiving the input, the LLM may generate a word such as, for example, “learn” or “understand,” and place the generated word into a string to create the original distribution P. Since the LLM operates in an autoregressive manner, the LLM may repeat the generation of the word/token to create the distribution P (e.g., full sentence).

With the input string “AI can,” it may be possible to extract a context code c which may be used to influence the generation of the next token without modifying the original context itself. On the other hand, when the learning model generates a complete sentence, each newly generated token may be appended to the context. In this sense, the context does not change—as the generation proceeds, the context grows to include all tokens that have already been produced. In certain embodiments, the context extracted from the input may be of any predefined length (e.g., long and short sentences). In some embodiments, a predefined number of recent words may be extracted into a context code c using the latest (e.g., most recent) tokens of the full context (e.g., input string). In certain embodiments, the size of the context code c may be a hyper-parameter may be selected by a system designer, and any integer value may be used. In some embodiments, 1 to 5 tokens may be sufficient for the context code c. Increasing the size of the context code c may strengthen the watermark. However, the increased size may also make the context code c less robust to edits or paraphrasing. In contrast, decreasing the size of the context code c may reduce the watermark's strength, but improve its resilience to modifications.

Furthermore, the context may bind the watermarked token to the surrounding text, and a reweighting performed at each step may depend on the current context resulting in watermark distribution changes. In some embodiments, the context may be needed in the detection of the watermark. For example, detection of the watermark may require the same prior context that was present when the token was generated. Although, small edits to the surrounding text of the context may alter the context codes and therefore the watermark distribution, the watermark may still be recovered in long passages.

As an example of the effect of small context edits, the original watermarked sentence may be: “I like to eat apple for breakfast, savoring the crisp snap and the burst of tart-sweet juice that wakes me up.” Now an edit to a single word is made to obtain: “I like to eat apple for breakfast, because the crisp snap and the burst of tart-sweet juice that wakes me up.” In this example, the words “apple for breakfast” keep the same three-word context and, thus, their watermark code is unchanged. The word “the” that follows the edit now sees a different three-word window where the old context was “breakfast”, “savoring”, and “the”. However, after the edit, it becomes “breakfast”, “because”, and “the”. Consequently, the context codes for “crisp” and “snap” also shift (e.g., their preceding three words change), while words later in the sentence retain the original context code. Thus, from this example, both the private key k and the context can shape the watermarked token distribution, and both may be needed for reliable detection.

After a context conde c is extracted (which may change at each iterative step) a private key k may be introduced with the context code c to generate the watermark code E. The token may be considered watermarked relative to a specific private key k and the exact context at the moment the token was generated. As such, detection of watermarking may use both the context and the private key k; otherwise, a low detection score may result. In some embodiments, the private key k may be unique for each user without any conflict between users. For instance, the private key k may be associated with the identity of the user, which may enable the production of distinct watermark patterns. The private key k may provide secrecy and identity, and using the wrong private key k may typically result in failure of detecting the watermark, and may also lead to different generated outputs.

As illustrated in FIG. 3, the context code c and the private key k may be combined and added to a hash function to determine the watermark code E. The watermark code E may then be used as one parameter in the unbiased reweighting function to detect the watermarking. The output obtained from the watermark code E corresponds to a watermarked distribution Q. That is, the watermarked distribution is created by applying the reweighting operator R to the original distribution P using the watermark code E as a parameter: watermarked distribution=R^{E} (Original Distribution).

In some example embodiments, for any unbiased reweighting function and context code space, an unbiased watermark code generation function always exist. According to some example embodiments, pseudorandom numbers may be used to implement the unbiased watermark code generation function. Specifically, the hash value hash(c,k) may be used as a random seed to sample E from P_{E} as an implementation of E=Ê(c,k). In certain embodiments, an unbiased watermark code generation function may ensure that the watermark codes Eᵢ are independent with each other if only their context codes are different. During the generation of a sequence, context codes may be repeated. If cᵢ and cⱼ are equal, then Eᵢ and Eⱼ are also equal, violating the independence of Eᵢ. It may be possible to skip reweighting for a token when encountering a previously used context code by, for example, setting P_{M,w}(⋅|a_{1:m}, x_{1:i-1})=P_{M}(⋅|a_{1:m}, x_{1:i-1}) if the context code has previously appeared.

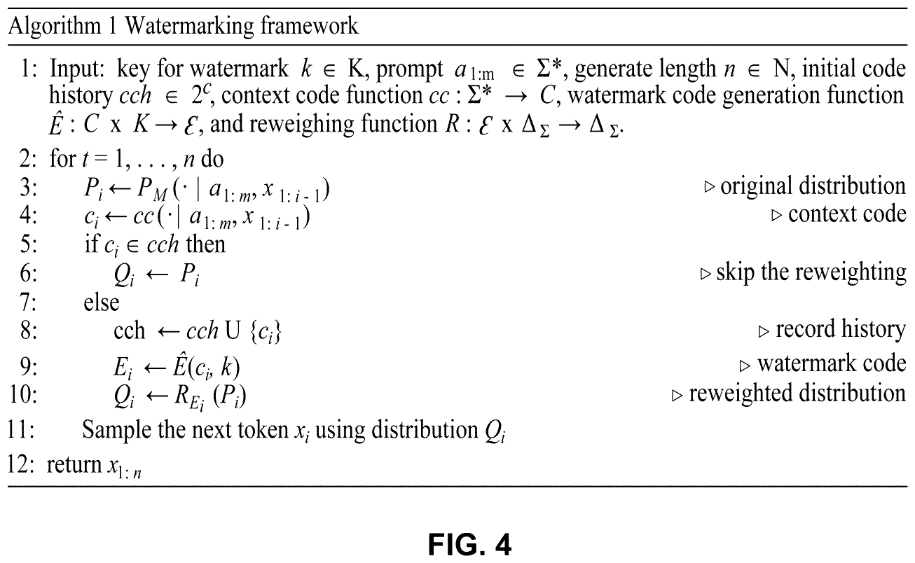

FIG. 4 illustrates an example framework for watermarking, according to certain embodiments. As illustrated in FIG. 3, the framework may include two components to be implemented: the unbiased reweight function R_{E} and the context code function c.

According to certain embodiments, it may be possible to detect watermarking. As described herein, there is a process of adding a watermark to a text based on a secret key k and a given prompt a_{1:m}. The watermark-embedded text may be sampled from the distribution P_{M,w}(x_{1:n}|a_{1:m}; k). This problem may be formulated as a statistical hypothesis test between two competing hypotheses: H₀, which posits that x_{1:n} follows the unmarked distribution, and H₁, which posits that X_{1:n} follows the marked distribution.

In certain example embodiments, a score-based testing may be provided, which assigns a score to each token in the text. The score may be interpreted as the confidence that the token was generated by the watermark model rather than the original model. Scores sᵢ may be determined based on x_{1:i}, in accordance with the autoregressive manner of the generation process.

The total score S may be given by

$$S = {\sum }_{i = 1}^{n} {s}_{i} .$$

A threshold Ŝ may be set such that if S<Ŝ, the null hypothesis H₀ is accepted, indicating insufficient evidence to conclude that the text contains a watermark. Otherwise, the null hypothesis is rejected. In certain embodiments, there may be two types of error probabilities associated with the decision process including, for example, a type I error and a type II error. In a type I error, the probability of incorrectly rejecting the null hypothesis is under H₀, denoted as P_{H}_{₀}(S≥Ŝ). In a type II error, the probability of incorrectly accepting the null hypothesis is under H₁, denoted as P_{H}_{₁}(S<Ŝ).

Theoretical results may be derived by utilizing specific properties of the scores. For example, under the null hypothesis H₀, the exponential momentum of sᵢ is bounded, conditioned on the preceding context x_{1,i-1}. This requirement leads to an upper bound on a, the type I error probability.

According to certain embodiments, detection of watermarking may also be performed by rerunning the watermarking workflow to obtain multiple distributions (where each position only computes one distribution), and checking how each distribution changes for each token. For instance, for a particular token, the probability of the old/original token may be increased to the new probability. This may be seen in FIG. 3 where the probability for the word “learn” is increased from the original distribution P to watermarked distribution Q, and the probability for the word “understand” is decreased from the original distribution P to the watermarked distribution Q. As such, during detection of the word “understand,” it is unlikely that there is watermarking because if there was watermarking, the word “learn” would be more likely to be observed. From the word “learn,” it is apparent that the probability increased after adding the watermark from the original distribution P to the watermarked distribution Q. As such, the word “learn” may be assigned a positive score indicating that watermarking is present. According to certain embodiments, if the input string is long with many tokens/words, a score may be determined for each token/word, after which all the scores may be aggregated. In some embodiments, there may be provided a statistically significant hypothesis test based on a threshold where the threshold S is defined as “S=log a.” The decision rule may be: no watermark if \(S<\hat S\); watermark present if \(S \ge \hat S\). Simply counting positive versus negative occurrences may discard the magnitude of the scores and, thus, is not equivalent to this test and does not provide an upper bound on the error rate.

To derive theoretical results, the scores may also have a particular property where the exponential momentum of sᵢ under H₀ should be bounded, conditioned on the previous text x_{1,i-1}. This requirement leads to an upper bound on the type I error rate.

Given a probability space (Ω, [symbol] , P) and a Σ-valued stochastic process Sᵢ:1≤i≤n, let

$${x}_{i} : 1 \leq i \leq n ,$$

$${ℱ}_{i}^{x} := σ ( {x}_{j} \vert 1 \leq j \leq i ) and {ℱ}_{i}^{s} := σ ( {s}_{j} \vert 1 \leq j \leq i )$$

as well as an [symbol] -valued stochastic process be the corresponding filtrations, where σ(⋅) denotes the σ-algebra generated by random variables. If

$${ℱ}_{i}^{s} ⊆ {ℱ}_{i}^{x} and 𝔼 [ exp ( {s}_{i} ) \vert {ℱ}_{i - 1}^{x} ] \leq 1 , then P ( {\sum }_{i = 1}^{n} {s}_{i} \geq t ) \leq {e}^{- t} .$$

Thus to ensure that the type I error probability has an upper bound α, the threshold Ŝ may be set as Ŝ=−log(α).

According to certain embodiments, an LLR test of the distribution may be performed. A LLR score is defined as

$${s}_{i} = log \frac{{P}_{M , w} ( {x}_{i} \vert {a}_{1 : m} , {x}_{1 : i - 1} ; k )}{{P}_{M} ( {x}_{i} \vert {a}_{1 : m} , {x}_{1 : i - 1} )} ,$$

and the total score becomes

$$S = log \frac{{P}_{M , w} ( {x}_{i : n} \vert {a}_{1 : m} ; k )}{{P}_{M} ( {x}_{i : n} \vert {a}_{1 : m} )} .$$

An optimization derivation of the above sᵢ may be provided to gain intuition and set the foundation for the maximum variant of the LLR score. For instance, it may be possible to set Pᵢ=P_{M}(⋅|a_{1:m},x_{1:i-1}), Qᵢ=P_{M,w}(⋅|a_{1:m}, x_{1:i-1}; k), and let sᵢ=Sᵢ(xᵢ)∈ [symbol] denote the score corresponding to different xᵢ. In this example, Pᵢ, Qᵢ, and Sᵢ are all functions with a signature of Σ→ [symbol] , thus equivalent to vectors of dimension |Σ|. The inner product may be defined as [symbol] Pᵢ,Sᵢ [symbol] =Σ_{x∈Σ}Pᵢ(x)Sᵢ(x).

The requirement

$$𝔼 [ exp ( {s}_{i} ) \vert {ℱ}_{i - 1}^{x} ] \leq 1$$

may be reformulated as (Pᵢ, exp(Sᵢ))≤1, where the exponential function is applied element-wise. Instead of minimizing the type II error directly, certain embodiments aim to maximize the average score under H₁ (e.g., [symbol] Qᵢ, Sᵢ [symbol] ). The optimization problem becomes max_{S}_{ᵢ} [symbol] Qᵢ,Sᵢ [symbol] , s.t. [symbol] Pᵢ,exp(Sᵢ) [symbol] ≤1. The optional solution is given by

$${S}_{i} ( x ) = log \frac{{Q}_{i} ( x )}{{P}_{i} ( x )} ,$$

which recovers the optimal log likelihood ratio score.

According to certain embodiments, the LLR test may be implemented to distinguish between the original distribution P and the watermarked distribution Q. the LLR test may achieve the optimal trade-off between type I (false positive) and type II (false negative) errors. The LLR test compares the likelihood of a given text under P and Q, and if the ratio exceeds a threshold, the text is classified as watermarked. To ensure an upper bound for type I error, the threshold Ŝ=−log(α).

In certain embodiments, a maximin variant of the LLR score may be provided. A limitation of the LLR score described above is that when Qᵢ(x)=0, Sᵢ(x)=−∞. This means that as long as a single token does not come from the watermark model P_{M,w}, the score becomes negative infinity, making it impossible to reject the null hypothesis H₀.

Another reason for the drawback of the LLR score is that the watermark model P_{M,w} used in the detection process may not exactly match the true distribution of the watermarked text. For instance, potential sources of discrepancy may include editing (e.g., a text sampled from P_{M,w} may undergo some degree of editing before watermark detection) and imperfect estimation of the generation process (e.g., due to lack of knowledge of the exact prompt and temperature used during generation).

To address the issues with the LLR score, certain embodiments may consider a perturbed generation distribution. For example, instead of the original hypothesis H₁, where x_{1:n} follows the watermark distribution P_{M,w}, it may be assumed that x_{1:n} follows a distribution P′_{M,w}, which is similar to but not identical to P_{M,w}. Specifically, during the generation of each token, the total variation (TV) distance between Q′ᵢ and Qᵢ is bounded by d.

According to certain embodiments, the TV measures the overall discrepancy between two discrete probability distributions P and Q. In one example, a TV of 0 means the distributions are identical, and a TV of 2 is the maximum possible difference. Q represents the watermarked next-token distribution at step i, obtained by applying the unbiased reweighting to the model's original prediction. Q′ᵢ represents a perturbed version of Qᵢ used at detection time to model edits/post-processing, and Q′ᵢ may differ from Qᵢ. The bounded variable d represents a hyper-parameter that controls how much perturbation is allowed when forming Q′ᵢ. For example, larger values of d correspond to assuming that more editing or noise has occurred between the generation of the watermarked text and the detection step.

In certain embodiments, TV may provide a simple uncertainty set (a TV ball) around Qᵢ to model the worst-case edits between generation and detection. The TV may provide a linear form that makes the maximum variant of the LLR detection problem easy to solve.

Based on the above, a corresponding new optimization problem may be provided as follows:

$${max}_{{S}_{i}} {min}_{{Q}_{i}^{′} ∈ {Δ}_{\sum } , TV ( {Q}_{i}^{′} , {Q}_{i} ) \leq d} 〈 {Q}_{i}^{′} , {S}_{i} 〉 , s . t . 〈 {P}_{i} , exp ( {S}_{i} ) 〉 \leq 1.$$

Intuitively, the optimal solution for Q′ᵢ in the inner optimization decreases Q′ᵢ(x) when Sᵢ(x) is large, and increases Q′ᵢ(x) when Sᵢ(x) is small.

The computation of the maximin solution may be performed efficiently in Õ(|Σ|) time. Additionally, the maximum variant of the LLR score may be more robust than the standard LLR score, as it yields higher scores when the text has undergone some degree of editing.

According to certain embodiments, a hyperparameter d∈[0,1] represents the perturbation strength, and is introduced in the LLR score. If the text to be detected has undergone more editing and deviates further from the distribution P_{M,w}, d should be larger. In some embodiments, it may be recommended to use a grid search to select the best value of d. Assuming there are A candidate values for d, corresponding to A difference scores

$${s}_{i}^{( a )} ( 1 \leq a \leq A ) ,$$

it may be possible to modify the following equation with multiple scores

$${s}_{i}^{( a )}$$

to obtain

$$P ( {max}_{1 \leq a \leq A} ( {\sum }_{i = 1}^{n} {s}_{i}^{( a )} ) \geq t ) \leq {Ae}^{- t} .$$

Thus, when using grid search, the final threshold may be adjusted as Ŝ=−log(α)+log(A).

According to the above embodiments, it may be possible to account for the sensitivity of the LLR test to perturbations in both P and Q. For instance, if the text is modified before watermark detection, the true watermarked distribution may differ from the assumed Q. To address this issue, a robust LLR test may be implemented to introduce a distribution-robust optimization term. This term allows for a small perturbation in Q, making the test more resilient to text modifications while still maintaining its detection power.

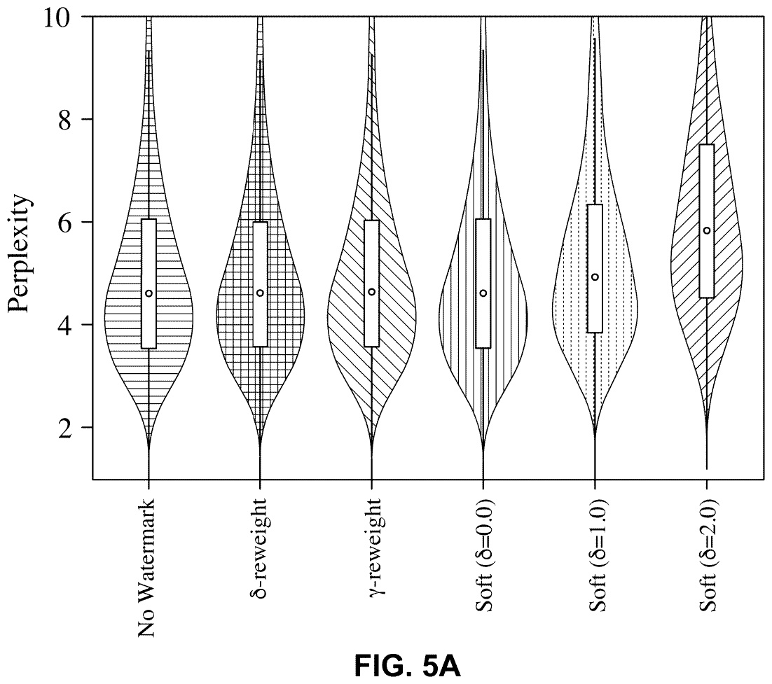

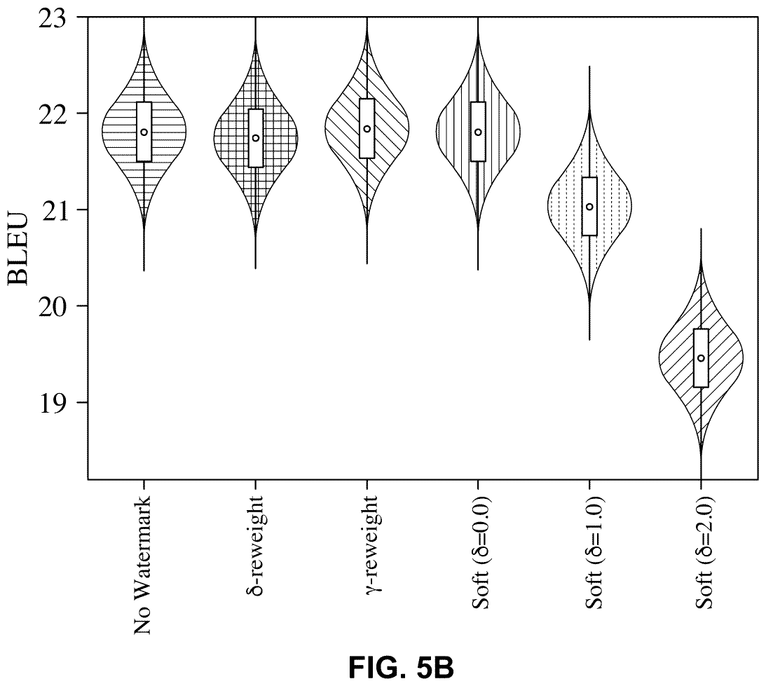

FIG. 5A illustrates an example distribution of perplexity of outputs for text summarization (TS) and bilingual evaluation understudy (BLEU) score for machine translation (MT), according to certain embodiments. Further, FIG. 5B illustrates an example of another distribution of perplexity of outputs for TS and BLEU score for machine translation (MT), according to certain embodiments. FIGS. 5A and 5B demonstrate that the unbiased watermarking method preserves output quality. For example, there is no observable difference in either the mean (average) or distribution of output quality compared to non-watermarked outputs. In contrast, other biased watermarking methods show a clear quality degradation. This empirically verifies that the unbiased method is truly unbiased, as it maintains the original model's performance without compromising quality.

In certain embodiments, the performance of unbiased watermarks may be evaluated on two applications of seq2seq models: text summarizations (TS) and machine translation (MT). For the TS task, the BART-large model was used and the CNN-DM corpus was used as the testing dataset. The MT task involves translating English to Romanian, for which the Multilingual BART (MBart) model was employed on the WMT′ 14 En-Ro corpus.

According to certain embodiments, it may be possible to determine whether the watermarking procedure is biased or unbiased. For instance, to resolve any bias issue in the output of the learning model, a single watermarked distribution Q may be used. In one example, the bias in the output of the learning model may be resolved while maintaining quality, by employing unbiased reweighting whereby a family of watermarked distributions Q_{E} parameterized by a random watermark code E is used such that E[Q_{E}]=P. In another example, multiple watermarked distributions may be used including, for example, Q₀ and Q₁, whose combination recovers the original distribution P. The choice between Q₀ and Q₁ may depend on a secret key k. For an observer without the secret key k, the expected output distribution from the watermarked model is identical to the original model, ensuring unbiasedness. However, for someone with the secret key k, the likelihood ratio between the corresponding Qᵢ and P could be large, allowing for reliable watermark detection. This approach may effectively resolve the dilemma between watermark strength and watermark bias.

In certain embodiments, an approach to resolve biasedness may include utilizing two components: an unbiased reweight; and using each watermark only once. In the first component, use of the unbiased reweight may take the form of: Q=R_{E}(P) [symbol] _{E}[R_{E} (P)]=P. Here, the unbiased reweighting may ensure that the expected watermarked distribution matches the original distribution. In the first component, a determination may be made as to whether generation of a single token is unbiased by checking the distribution without a watermark and the distribution after watermarking to obtain two distributions. The watermarked distribution may depend on the private key k. If the expectation of watermarked distribution with regard to the private key k recovers the original distribution, it satisfies the math equation and is unbiased.

According to certain embodiments, if the identity of the user/private key k is changed, a different distribution may be obtained. If there are an excess number of watermark keys and distributions, the average of the distributions may be obtained, and the average may cover the original distribution, which is classified as “unbiased.”

As to the second component, each watermark code may only be used once in the generation process to ensure that the distribution of tokens for an entire sentence is unbiased. To accomplish this unbiasedness, the system is restricted from using the same watermark code more than once. If the same watermark code appears again, it is skipped and the watermark is not added. Since the watermark is abstract representing information from the context code and private key, the only changing part is the context code. As such, only the context code may need to be checked if it is a duplicate of a previous context code by referencing the recorded context code history.

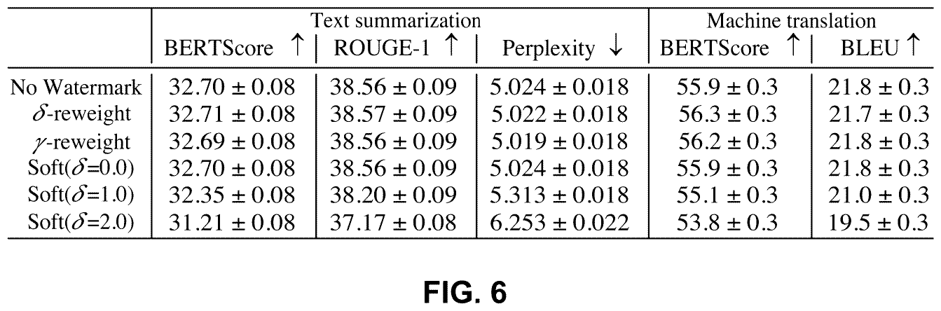

FIG. 6 illustrates a table of performance results of different watermarking methods, according to certain embodiments. Specifically, the table of FIG. 6 includes performance results of different watermarking methods on TS and MT where F1 scores of BERTScore and scale BERTScore and ROUGE−1 scores are used with a factor of 100. As shown in FIG. 5, a comparison is made between the performance of the unbiased watermarking methods which include the δ-reweight and the γ-reweight, with the soft-red-list method. The watermark strength in the soft-red-list approach is controlled by a parameter δ.

As shown in FIG. 6, from the quality of the output post-watermarking, it may be observed that the output quality remains unaffected by the unbiased watermark methods, both for the δ-reweight and the γ-reweight, irrespective of the task and metric. Conversely, the soft-red-list method, when δ=0, does not introduce any watermark and there fore does not affect the output quality. However, for δ>0, it may significantly impair the quality of the output.

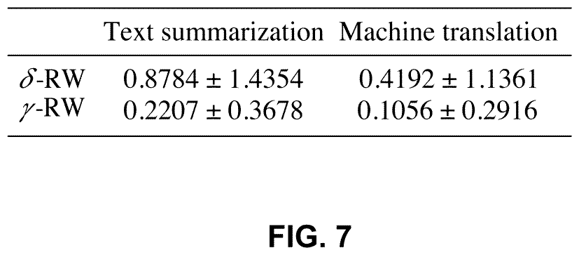

In terms of watermark detection, the score associated with each token may be determined. The mean and variance of the score per token for TS and MT are presented in FIG. 7, which illustrates the mean and variance score per token for different reweighting methods and different tasks, according to certain embodiments. As a heuristic, if the sum of the scores for all tokens in a sentence reaches 10, a p-value of less than 0.0005 may be ensured. If the sum score reaches 20, the p-value must be less than 3e-8.

According to certain embodiments, the unbiased watermark may also be detected in a likelihood-agnostic way such that it does not rely on a language model and its output logits to compute the score. For instance, in some embodiments, the same δ-reweighting described above may be used with a different implementation. Instead of using inverse sampling, the Gumbel trick may be applied. Specifically, each watermark code may be a list of |Σ| number of independent and identically distributed standard Gumbel variables. The watermark code space is ε= [symbol] ^{Σ}. The probability density function of the watermark code is given by

$${P}_{E} ( E ) = {\prod }_{a ∈ \sum } {e}^{- E ( a ) + {e}^{E ( a )}} .$$

To sample a token using the Gumbel trick, a*=argmaxₐ{log P(a)+E(a)} is computed, and the reweighted distribution becomes Q=δ_{a*}. The Gumbel variables provide the ability to guess the likelihood of a token coming from the watermark model without relying on logits, as tokens with larger Gumbel variables are more likely to be picked by the watermark model.

In certain embodiments, scores for each token may be calculated without relying on the original and reweighted distribution P and Q. Thus, the design of the likelihood-agnostic score may have a certain degree of arbitrariness. In certain embodiments, the score may be selected to be sᵢ=In2−exp(−E(a*)). One concern of this construction is that it may yield a tail bound. For n independent random variables Gᵢ˜Gumbel(0,1), if sᵢ=In2−exp(−Gᵢ) is defined, the following may be achieved: [symbol] [exp(sᵢ)]≤1 and

$$P ( {\sum }_{i = 1}^{n} {s}_{i} \leq t ) \leq {e}^{- t} .$$

For a token with watermark, the average score is [symbol] [In2−exp(−Gᵢ(a*))]=In2−Σ_{a∈Σ}P(a)²=In2−exp(−H₂(P)), where H₂(P) is the Rényi entropy of order 2. Thus, the average score may be positive only when the entropy is high.

According to certain embodiments, the n independent random variables may require independence of sᵢ. The Gumbel variables may depend on the watermark code, and the watermark code may repeat, leading to dependencies between Gumbel variables and, thus, between scores. To address this issue, for repeating context codes, the score may be set to zero, ensuring that the n independent random variables remain appliable.

In certain embodiments, the detection process may be as follow, given a text x_{1:n}=(x₁, . . . , xₙ), it may be possible to obtain a series of context codes (cc₁, . . . , ccₙ) and watermark codes (E₁, . . . , Eₙ). The final scores may be determined as:

$${s}_{i} = \{ \begin{matrix}ln 2 - exp ( - {E}_{i} ( {x}_{i} ) ) & if {cc}_{i} ∉ {cc}_{1} , … , {cc}_{i - 1} , \\ 0 & if {cc}_{i} ∈ {cc}_{1} , … , {cc}_{i - 1} .\end{matrix}$$

From the above examples, it can be seen that the likelihood-agnostic approach may assume that there is no knowledge of the language model probability of the original distribution. For instance, in the example sentence “I like to eat apple for breakfast”, under the likelihood-agnostic approach, there is no knowledge of the language model probability that “apple” follows the prefix “I like to eat”. Instead of consulting the model's conditional probabilities, the detection relies on the token itself, and the watermark code derived from the token and the surrounding context.

According to certain embodiments, a new score may be determined from the token and the watermark code. Because the new score does not incorporate ethe true token likelihood, the score may be viewed as a “weak” or noisier approximation of the likelihood-based score. Consequently, the new score may be lower and more tolerant of uncertainty.

Similar to the likelihood-based detection described herein, the likelihood-agnostic approach may include recomputing the codes. In this re-computation, for each position in the candidate text, the context code is recomputed from the observed preceding tokens and then combined with the private key to obtain the watermark code for that position.

Once the re-computation is completed, a simple match signal sᵢ may be determined using the observed token at I and the watermark code at i. The match signal sᵢ measures how well the token aligns with the keyed code.

To obtain the score S, an aggregation is performed by taking the sum or average of the signals over positions. The score S may be compared to a precomputed null distribution (e.g., what S would look like without a watermark) to obtain a p-value or threshold decision. With the score S, it may be possible to perform a decision where if S exceeds the threshold, the text is declared watermarked; otherwise, watermarking is not detected. Thus, by implementing the likelihood-agnostic detection, the explicit language model likelihood is discarded, and the decision is based solely on the token-plus-watermark information, trading accuracy for reduced computational cost.

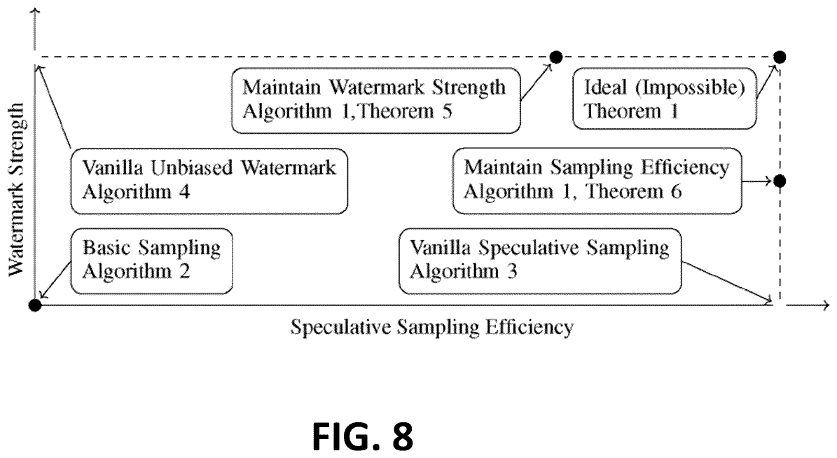

FIG. 8 illustrates an example comparative diagram of trade-offs between watermarking strength and speculative sampling efficiency, according to certain embodiments. As illustrated in FIG. 1, the ideal case of maintaining both watermark strength and sampling efficiency may nearly be impossible. However, certain embodiments may provide ways to focus on maintaining either the watermark strength or sampling efficiency.

To evaluate the effectiveness of the framework, two metrics may be considered: watermark strength and acceleration performance. According to certain embodiments, under the two reweight framework, it may be impossible to simultaneously maintain both the watermark strength and the sampling efficiency when a vocabulary size is greater than two. This result highlights the inherent trade-off between watermarking and acceleration in the context of LLMs.

According to certain embodiments, a language model may define a probability distribution over sequences of tokens from a vocabulary set 2. The language model may assign a probability P(xₙ₊₁|x₁, x₂, . . . , xₙ) to the next token xₙ₊₁ given the context of previous tokens x₁, x₂, . . . , xₙ. Certain embodiments may use Δ_{Σ} to denote the set of all possible probability distributions over the vocabulary set Σ.

According to certain embodiments, a watermarking scheme may be defined as a tuple (ε, P_{E}, R), where ε is a set of watermark codes, P_{E} is a probability distribution over ε, and R:ε×Δ_{Σ}→Δ_{Σ} is a reweighting function that maps a watermark code E∈ε and a probability distribution P∈Δ_{Σ} to a watermarked distribution R_{E}(P)∈Δ_{Σ}. According to some embodiments, unbiased watermarking schemes may be provided that satisfy [symbol] _{E˜P}_{_{E}}[R_{E}(P)]=P for all P∈Δ_{Σ}, unless explicitly stated otherwise.

To generate a watermarked token x, a watermark code E˜P_{E} may be determined based on a context, and then the token may be sampled from the watermarked distribution such as, for example, x˜R_{E}(P). The context may correspond to an input text, conversation history, and/or instructions. In other embodiments, the context may correspond to a prefix, referring to the complete, evolving input available to the model at a specific generation step.

The presence of the watermark may be detected by statistical tests. For example, the pivotal quantity used in the tests may be referred to as a watermark score. In particular, a higher watermark score implies a more detectable watermark. Additionally, the log likelihood ratio (LLR) may be a powerful score for detecting watermarks in the absence of any perturbations. However, more robust scores such as the maximum-LLR or likelihood-agnostic scores may be used. In certain embodiments, two specific watermark scores may be provided. For example, a maximum-LLR score as described in Zhengmian, et al., and the U score, which is a likelihood-agnostic score that can be defined for both DeltaGumbel reweight and Gamma reweight schemes.

The P-value may be determined by considering the absence of a watermark as the null hypothesis. For a score S with a known moment-generating function (MGF), the P-value may be upper bounded using the Chernoff bound:

$${P}_{null} ( S \geq \hat{S} ) \leq {min}_{λ \geq 0} 𝔼 [ {e}^{λ S} ] exp ( - λ \hat{S} ) . \qquad ( 1 )$$

Speculative sampling is a technique for accelerating the generation of tokens from a target model P by leveraging a faster draft model Q. For instance, a draft token \tilde{x} may be sampled from the draft model Q, and then accept or reject it based on the ratio of the target and draft probabilities. If the draft token is rejected, a new token is sampled from a residual distribution proportional to the difference between the target and draft probabilities. Formally, the speculative sampling process generates a token x as follows:

$$𝒫 ( x = j \vert \tilde{x} = i ) = \{ \begin{matrix}min ( 1 , \frac{P ( i )}{Q ( i )} ) & if i = j , \\ \frac{{( 1 - \frac{P ( i )}{Q ( i )} )}_{+} {( P ( j ) - Q ( j ) )}_{+}}{{\sum }_{z ∈ \sum } {( Q ( z ) - P ( z ) )}_{+}} & if i \neq j ,\end{matrix} \qquad ( 2 )$$

$${( x )}_{+} = max ( 0 , x )$$

where (x)₊=max (0, x). The design of the speculative process may ensure that the final distribution of the generated token x matches the target distribution P. The efficiency of speculative sampling may be measured by the overlap probability α(P,Q)=Σ_{t∈Σ}min (P(t), Q(t)), which is the probability of accepting the draft token in each step. The overlap probability is related to the total variation distance between P and Q by TV(P,Q)=1−α(P,Q). Such a speculative sampling process may be applied multiple times to generate and verify multiple draft tokens in one step.

As described above, certain embodiments may provide a two reweight framework for accelerating the generation of watermarked tokens based on speculative sampling techniques. By implementing the two reweight framework, it may be possible to apply speculative sampling to a watermarked target distribution R_{E}(P), which may significantly reduce the overlap probability α(R_{E}(P), Q) with the draft distribution Q, leading to a small sampling efficiency.

According to certain embodiments, by implementing the two reweight framework may also be possible to apply a separate reweighting function R′ to the draft distribution Q. This may be accomplished by, for example, using a watermark code E, which is the same watermark code used for reweighting the target distribution. By doing so, it may be possible to increase the overlap probability between the watermarked target distribution R_{E}(P) and the watermarked draft distribution R′_{E}(Q) (e.g., α(R_{E}(P), R′_{E}(Q))), thus improving the sampling efficiency.

In certain embodiments, the watermarked draft distribution may be defined using another reweighting function (ε, P_{E}, R′), where R′:∈×Δ_{Σ}→Δ_{Σ}, is a function that maps a watermark code E∈ε and a draft distribution Q∈Δ_{Σ} to a watermarked draft distribution R′_{E}(Q)∈Δ_{Σ}. The framework itself may not require the watermarked draft distribution to be unbiased (e.g., [symbol] _{E˜P}_{_{E}}[R′_{E}(Q)]−Q for all Q∈Δ_{Σ}, and as defined in Zhengmian et al.). However, this unbiasedness property may naturally emerge when the final output distribution is needed to be unbiased and to improv ethe sampling efficiency. In certain embodiments, “unbiased” may correspond to property of the reweight function. The reweight function may be unbiased if, when an average over the (random) watermark code is performed, the expected watermarked distribution equals the original distribution. Since reweighting may be dependent upon the specific watermark code, treating the code as random may induce a random watermarked distribution. The left-hand side of the unbiased expression is the average (expectation) of these watermarked distributions, and the right-hand side is the original distribution. The equality indicates that, in expectation over watermark codes, reweighting recovers the original distribution.

According to certain embodiments, a watermarked token may be generated by sampling a draft token % from the watermarked draft distribution (e.g., \tilde{x}˜R′_{E}(Q)) or equivalently P(\tilde{x}=i)=R′_{E}(Q)(i) for all i∈Σ. Then, speculative-sampling verification may be applied to the draft token, yielding the generated token x. According to certain embodiments, the speculative sampling may be defined by a conditional probability distribution A(j|i) for all i, j∈Σ, where A(⋅|i)∈Δ_{Σ} for each i. The design of A may depend on the target distribution P, the draft distribution Q, and the watermark code E. The probability of generating a token x=j given a draft token \tilde{x}=i is given by [symbol] (x=j|\tilde{x}=i)=A(j|i).

In certain embodiments, the distribution fo the generated token (e.g., the generation distribution) may be determined as follows:

$$𝒫 ( x = j ) = {\sum }_{i ∈ \sum } 𝒫 ( x = j \vert \tilde{x} = i ) ; 𝒫 ( \tilde{x} = i ) = {\sum }_{i ∈ \sum } A ( j \vert i ) {R}_{E}^{′} ( Q ) ( i ) = ( A ◦ {R}_{E}^{′} ( Q ) ) ( j ) . \qquad ( 3 )$$

The generation distribution may be denoted by \hat{R}_{E}(P)=A∘R′_{E}(Q). To ensure that the two reweight framework produces an unbiased output distribution, for all P∈Δ_{Σ}:

$${𝔼}_{E ∼ {P}_{E}} [ {\hat{R}}_{E} ( P ) ] = P . \qquad ( 4 )$$

According to certain embodiments, a no-go theorem may be provided showing the unfeasibility of simultaneously maintaining watermark strength and sampling efficiency when the vocabular size is greater than two. For instance, when the vocabulary size is |Σ|>2, there does not exist non-trivial reweighting functions R:ε×Δ_{Σ}→Δ_{Σ} and R′:ε×Δ_{Σ}→Δ_{Σ}, and a speculative process A(j|i) such that for all P,Q∈Δ_{Σ}: (1) the watermark strength is maintained, \hat{R}_{E}(P)=R_{E}(P); and (2) the sampling efficiency is maintained, α(P,Q)= [symbol] _{E˜P}_{_{E}}[Σ_{i∈Σ}(i|i)R′_{E}(Q)(i)].

In certain embodiments, the condition for maintaining the watermark strength may be represented as \hat{R}_{E}(P)=R_{E}(P), which may ensure that the watermark strength is maintained by keeping the average watermark score unchanged. For example, the scoring may be represented as the following:

$${𝔼}_{E ∼ {P}_{E}} {𝔼}_{t ∼ {R}_{E} {\underbrace{( P )}}_{w :=}} [ Score ( t , E ) ] = {𝔼}_{E ∼ {P}_{E}} {𝔼}_{t ∼ {\hat{R}}_{E} {\underbrace{( P )}}_{{w}^{′} :=}} [ Score ( t , E ) ] , \qquad ( 5 )$$

where Score (t,E) is an arbitrary function that measures the watermark strength.

According to certain embodiments, to ensure that the watermark strength remains unchanged, w=w′, and the condition \hat{R}_{E}(P)=R_{E}(P) may be a sufficient condition. However, due to the large design space of scoring functions, to maintain w=w′ for every possible score, then \hat{R}_{E}(P)=R_{E}(P) becomes a necessary condition. On the other hand, for a fixed scoring function and a specific R_{E}, it may be possible that \hat{R}_{E}(P)≠R_{E}(P) while w=w′ or even w<w′. In other words, the condition \hat{R}_{E}(P)=R_{E} (P) may not always be necessary to maintain the watermark strength for a specific scoring function and reweighting function.

In certain embodiments, proof of the no-go theorem may rely on several lemmas, which reveal the connections between maintaining the sampling efficiency, maintaining the watermark strength, and maintaining the properties of the reweighting functions.

In one lemma A, maintaining the sample efficiency may imply an unbiased watermarked draft model. For instance, if for all P,Q∈Δ_{Σ}, we have

$$α ( P , Q ) = {𝔼}_{E ∼ {P}_{E}} [ {\sum }_{i ∈ \sum } A ( i \vert i ) {R}_{E}^{′} ( Q ) ( i ) ] ,$$

then [symbol] _{E˜P}_{_{E}}[R′_{E}(Q)]=Q. In another lemma B, maintaining the watermark strength and sampling efficiency may imply the same reweight function. In this regard, under the two reweight framework, if for all P,Q∈Δ_{Σ}, we have

$$α ( P , Q ) = {𝔼}_{E ∼ {P}_{E}} [ {\sum }_{i ∈ \sum } A ( i \vert i ) {R}_{E}^{′} ( Q ) ( i ) ] , {\hat{R}}_{E} ( P ) = {R}_{E} ( P ) ,$$

then R′_{E}(Q)=R_{E}(Q) for all Q∈Δ_{Σ}.

With the above lemmas, it may be possible to prove the no-go theorem. For example, according to lemma B, maintaining both the watermark strength and sampling efficiency under the two reweight framework implies that R′_{E}(Q)=R_{E}(Q) for all Q∈Δ_{Σ}. Thus, the following expression may be obtained:

$$α ( P , Q ) \leq {𝔼}_{E ∼ {P}_{E}} [ α ( {R}_{E} ( P ) , {R}_{E} ( Q ) ) ] . \qquad ( 6 )$$

Equation (6) may be obtained from:

$${R}_{E} ( P ) ( i ) = {\hat{R}}_{E} ( P ) ( i ) = {\sum }_{j} A ( i \vert j ) {R}_{E} ( Q ) ( j ) \geq A ( i \vert i ) {R}_{E} ( Q ) ( i ) ,$$

$${R}_{E} ( Q ) ( i ) \geq A ( i \vert i ) {R}_{E} ( Q ) ( i ) ,$$

$$A ( i \vert i ) {R}_{E} ( Q ) ( i ) \leq min ( {R}_{E} ( Q ) ( i ) , {R}_{E} ( P ) ( i ) ) .$$

Summing over I, the following may be obtained:

$${\sum }_{i} A ( i \vert i ) {R}_{E} ( Q ) ( i ) \leq {\sum }_{i} min ( {R}_{E} ( Q ) ( i ) , {R}_{E} ( P ) ( i ) ) = α ( {R}_{E} ( Q ) , {R}_{E} ( P ) ) .$$

Taking the expectation over E, Equation (6) is obtained.

As previously noted, α(P,Q)=1−TV(P,Q), where TV(P,Q) denotes the total variation distance between P and Q. Thus, Equation (6) is equivalent to:

$$T V ( P , Q ) \geq {𝔼}_{E ∼ {P}_{E}} [ T V ( {R}_{E} ( P ) , {R}_{E} ( Q ) ) ] . \qquad ( 7 )$$

Viewing P,Q∈Δ_{Σ} as n-dimensional vectors, where n=|Σ|, the total variation distance may be expressed as:

$$2 T V ( P , Q ) = {max}_{u ∈ {[ - 1 , 1 ]}^{n}} 〈 u , P - Q 〉 , \qquad ( 8 )$$

Where the maximum is attained at u*(P,Q)=sign(P−Q). Using this expression, it may be possible to obtain the following:

$${𝔼}_{E ∼ {P}_{E}} 2 T V ( {R}_{E} ( P ) , {R}_{E} ( Q ) ) = {𝔼}_{E ∼ {P}_{E}} [ {max}_{u ∈ {[ - 1 , 1 ]}^{n}} 〈 u , {R}_{E} ( P ) - {R}_{E} ( Q ) 〉 ] \geq {𝔼}_{E ∼ {P}_{E}} 〈 u * ( P , Q ) , {R}_{E} ( P ) - {R}_{E} ( Q ) 〉 \qquad ( 9 )$$

$$= 〈 u * ( P , Q ) , P - Q 〉 = 2 T V ( P , Q ) . \qquad ( 10 )$$

Combining Equations (7) and (10), it may be possible to conclude that the quality in Equation (9) must hold, which is equivalent to:

$${u}^{*} ( P , Q ) ∈ {Arg max}_{u ∈ {[ - 1 , 1 ]}^{n}} 〈 u , {R}_{E} ( P ) - {R}_{E} ( Q ) 〉 , \qquad ( 11 )$$

almost surely for random E. This condition is equivalent to the following:

$$( P - Q ) ( i ) = 0 ⇒ ( {R}_{E} ( P ) - {R}_{E} ( Q ) ) ( i ) = 0 , \qquad ( 12 )$$

$$( P - Q ) ( i ) \geq 0 ⇒ ( {R}_{E} ( P ) - {R}_{E} ( Q ) ) ( i ) \geq 0 , \qquad ( 13 )$$

$$( P - Q ) ( i ) \leq 0 ⇒ ( {R}_{E} ( P ) - {R}_{E} ( Q ) ) ( i ) \leq 0 , \qquad ( 14 )$$

almost surely for random E and for all i∈Σ.

According to certain embodiments, the symbols in the vocabulary Σ is set as i∈{1, . . . , n}. For a distribution P=(p₁, p₂, . . . , pₙ), the following is defined:

$${T}_{i} ( j ) = \{ \begin{matrix}{p}_{i} & j = i , \\ 1 - {p}_{i} & j = i mod n + 1 , \\ 0 & otherwise .\end{matrix}$$

For example, T₁=(p₁, 1−p₁, 0, . . . , 0), T₂=(0, p₂, 1−p₂, 0, . . . , 0), and Tₙ=(1−pₙ, 0, . . . , 0, pₙ). Let functions Fᵢ(pᵢ)=R_{E}(Tᵢ)(i). It may then be possible to claim that

$${R}_{E} ( P ) ( i ) = {F}_{i} ( {p}_{i} ) . \qquad ( 15 )$$

To better see the results of Equation (15), it is noted that (P−Tᵢ)(i)=pᵢ−pᵢ=0, so by Equation (12), it may be possible to obtain (R_{E}(P)−R_{E}(Tᵢ))(i)=0, which implies R_{E}(P)(i)=R_{E}(Tᵢ)(i)=Fᵢ(pᵢ).

According to certain embodiments, functions Fᵢ satisfy the following properties:

$${F}_{i} ( 0 ) = 0 , \qquad ( 16 )$$

$${F}_{i} ( 1 ) = 1 , \qquad ( 17 )$$

$${F}_{i} ( p ) is monotonically increasing in p , \qquad ( 18 )$$

$${\sum }_{i} {p}_{i} = 1 ⇒ {\sum }_{i} {F}_{i} ( {p}_{i} ) = 1 \qquad ( 19 )$$

To prove Equation (16), pᵢ=0 may be considered. In this case, Tᵢ(j)=1 if j=imodn+1 and Tᵢ(j)=0 otherwise. To ensure the unbiasedness of the reweighting function, [symbol] _{E˜P}_{_{E}}[R_{E}(Tᵢ)]=Tᵢ, which implies R_{E}(Tᵢ)=Tᵢ. Thus, R_{E}(Tᵢ)(i)=Tᵢ(i)=pᵢ=0, and Fᵢ(0)=0.

Similarly, to prove Equation (17), pᵢ=1 may be considered. In this case, Tᵢ(j)=1 if j=i and Tᵢ(j)=0 otherwise. To ensure the unbiasedness of the reweighting function, [symbol] _{E˜P}_{_{E}}[R_{E}(Tᵢ)]=Tᵢ, which implies R_{E}(Tᵢ)=Tᵢ. Thus, R_{E}(Tᵢ)(i)=Tᵢ(i)=pᵢ=1, and Fᵢ(1)=1.

Since pᵢ−p′ᵢ=(Tᵢ−T′ᵢ)(i)≥0, by Equation (13), Fᵢ(pᵢ)−Fᵢ(p′ᵢ)=(R_{E}(Tᵢ)−R_{E}(T′ᵢ))(i)>0 is obtained, which proves the monotonicity of Fᵢ. Additionally, to prove Equation (19), due to Equation (15), ΣᵢFᵢ(pᵢ)=ΣᵢR_{E}(P)(i)=1 is obtained. Further, the function Fᵢ satisfying Equations (16) to (19) may be the identity function (e.g., Fᵢ(p)=p for all i∈{1, 2, . . . , n} and p∈[0,1]. Combining this with Equation (15), it may be concluded that R_{E}(P)=P for random E, which means that the reweighting function R_{E} is trivial. Thus, when the vocabulary size |Σ|>2, it may be impossible to simultaneously maintain the watermark strength and sampling efficiency using non-trivial reweighting functions under the two reweight framework.

Certain embodiments may provide algorithms for maintaining watermark strength or sampling efficiency under the two reweight framework. In light of the no-go theorem, which precludes the simultaneous maintenance of watermark strength and sampling efficiency, it may be possible to provide a more detailed analysis of the trade-offs between maintaining watermark strength and sampling efficiency.

For instance, in maintaining watermark strength, the reweight function for the draft distribution may be the same as the reweight function for the target distribution (e.g., R′_{E}(Q)=R_{E}(Q)). The speculative process may be designed as follows:

$$A ( j \vert i ) = \{ \begin{matrix}min ( 1 , \frac{{R}_{E} ( P ) ( i )}{{R}_{E} ( Q ) ( i )} ) & if i = j , \\ \frac{{( 1 - \frac{{R}_{E} ( P ) ( i )}{{R}_{E} ( Q ) ( i )} )}_{+} {( {R}_{E} ( P ) ( j ) - {R}_{E} ( Q ) ( j ) )}_{+}}{{\sum }_{z ∈ \sum } {( {R}_{E} ( Q ) ( z ) - {R}_{E} ( P ) ( z ) )}_{+}} & if i \neq j .\end{matrix} \qquad ( 20 )$$

Under the two reweight framework, if R′_{E}(Q)=R_{E}(Q) and the speculative process A(j|i) is defined as in Equation (20), then the watermark strength may be maintained (e.g., \hat{R}_{E}(P)=R_{E}(P)). Moreover, the generation distribution is unbiased (e.g., [symbol] _{E˜P}_{_{E}}[R_{E}(P)]=P for all P∈Δ_{Σ}.

Equation (20) may apply the same reweighting function R_{E} to both the draft distribution Q and the target distribution P, and then perform speculative sampling based on the reweighted distributions R_{E}(Q) and R_{E}(P) as draft and target distributions.

According to certain embodiments, to maintain the watermark strength, the watermark may be applied to the draft tokens by sampling them from the watermarked draft model distribution, Q_{w}. Then, the watermarked target distribution P_{w} is determined, and speculative sampling is performed, treating Q_{w} as the draft model and P_{w} as the target model. Since the speculative sampling ensures that the generated content follows the distribution of the target model, the final generated results may be drawn from the distribution P_{w}. Consequently, the watermark strength remains unchanged compared to directly sampling from P_{w}.

In certain embodiments, the watermark strength may be stronger when the average score for each token becomes higher. In this sense, if the context is watermarked, the score may increase if the context may be longer because the score is determined as a sum of scores for each token, and a score is determined for the entire sequence of tokens.

In maintaining the sampling efficiency, the reweight function selected for the draft distribution may be the same as the reweight function for the target distribution (e.g., R′_{E}(Q)=R_{E}(Q)). However, the speculative process may be designed differently as follows:

$$A ( j \vert i ) = \{ \begin{matrix}min ( 1 , \frac{P ( j )}{Q ( i )} ) & if i = j , \\ \frac{{( 1 - \frac{P ( j )}{Q ( i )} )}_{+} {( P ( j ) - Q ( j ) )}_{+}}{{\sum }_{z ∈ \sum } {( Q ( z ) - P ( z ) )}_{+}} & if i \neq j .\end{matrix} \qquad ( 21 )$$

Under the two reweight framework, if R′_{E}(Q)=R_{E}(Q) and the speculative process A(j|i) is defined in Equation (21), then the sampling efficiency is maintained (e.g., α(P,Q)= [symbol] _{E˜P}_{_{E}}[Σ_{i∈Σ}A(i|i)R′_{E}(Q)(i)]. Moreover, the generation distribution is unbiased (e.g., [symbol] _{E˜P}_{_{E}}[\hat{R}_{E}(P)]=P for all P∈Δ_{Σ}.

According to certain embodiments, to maintain the sampling efficiency, the watermark may be applied to the draft tokens by sampling them from the watermarked draft model distribution Q_{w}. Then, speculative sampling may be performed, treating Q as the draft model and P as the target model. Under the expectation of random watermark codes, the draft tokens follow the distribution Q. Thus, the efficiency of speculative sampling remains unchanged compared to directly sampling draft tokens Q.

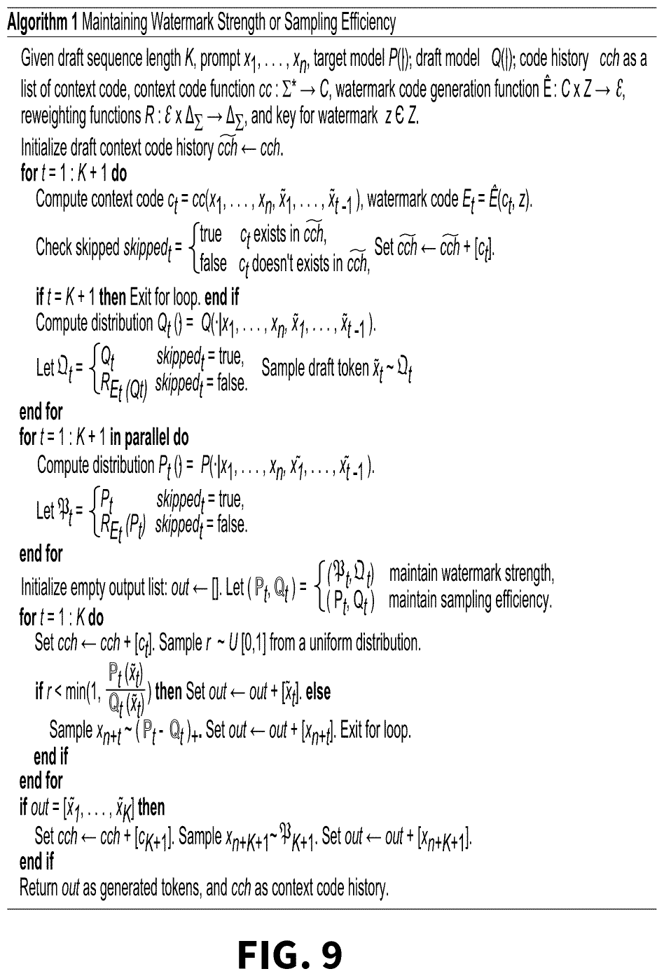

FIG. 9 illustrates an example algorithm for maintaining a watermark strength or maintaining a sampling efficiency, according to certain embodiments. As illustrated in FIG. 9, the algorithm may be applied to various methods multiple times in each step, and also considers the context code history to ensure unbiasedness for the entire sequence.

In some example embodiments, the context code history may ensure the unbiasedness of the entire generated sequence. All the draft tokens' context codes in the algorithms may be preserved in the context code history. Additionally, when a draft token is rejected, its context code may be preserved because of the newly generated random token after rejection (e.g., xₙ₊ₜ), is not independent of the rejected random draft token \tilde{x}ₜ. By preserving the right context code history, it may be possible toe ensure that not only the distribution of a single token, but also the distribution of the entire generated sequence is unbiased.

To verify that the algorithm in FIG. 9 can maintain either the watermark strength or the sampling efficiency, different methods on a text summarization task on CNN_DAILYMAIL dataset (see Tomás Kociský, Edward Grefenstette, Lasse Espeholt, Will Kay, Mustafa Suleyman, and Phil Blunsom. Teaching machines to read and comprehend. In Twenty-eighth Conference on Neural Information Processing Systems, pages 1693-1701, 2015, the teachings of which are incorporated herein by reference; and Abigail See, Peter J. Liu, and Christopher D. Manning. Get to the point: Summarization with pointer-generator networks. In Proceedings of the 55th Annual Meeting of the Association for Computational Linguistics (Volume 1: Long Papers), pages 1073-1083, Vancouver, Canada, July 2017. Association for Computational Linguistics, doi: 10.18653/v1/P17-1099, the teachings of which are incorporated herein by reference) using the Llama-7b model of Hugo et al. (see Hugo Touvron, Thibaut Lavril, Gautier Izacard, Xavier Martinet, Marie-Anne Lachaux, Timothée Lacroix, Baptiste Rozière, Naman Goyal, Eric Hambro, Faisal Azhar, et al. Llama: Open and efficient foundation language models, arXiv preprint arXiv:2302.13971, 2023, the teachings of which are incorporated herein by reference) as the target model and the Llama-68m model in Miao et al. (see Xupeng Miao, Gabriele Oliaro, Zhihao Zhang, Xinhao Cheng, Zeyu Wang, Rae Ying Yee Wong, Zhuoming Chen, Daiyaan Arfeen, Reyna Abhyankar, and Zhihao Jia. Specinfer: Accelerating generative Ilm serving with speculative inference and token tree verification, arXiv preprint arXiv:2305.09781, 2023, the teachings of which are incorporated herein by reference) as the draft model.

In verifying the algorithm of FIG. 9, the sampling efficiency may be measured by the number of accepted tokens in the out list of Algorithm 1, and the average accepted tokens per step (AATPS) may be reported, where a higher AATPS indicates a higher sampling efficiency.

According to certain embodiments, the log P-value may be computed to measure the watermark strength. For likelihood-based scores the computation follows the method described above. For the likelihood-agnostic scores, the U score may be used with the Chernoff bound in Equation (1), where λ is optimized numerically. The watermark strength may be tested for both the DeltaGumbel reweight and the Gamma reweight schemes. The Average Negative Log P-value Per Token (ANLPPT) may be reported, with a higher value indicating a stronger watermark.

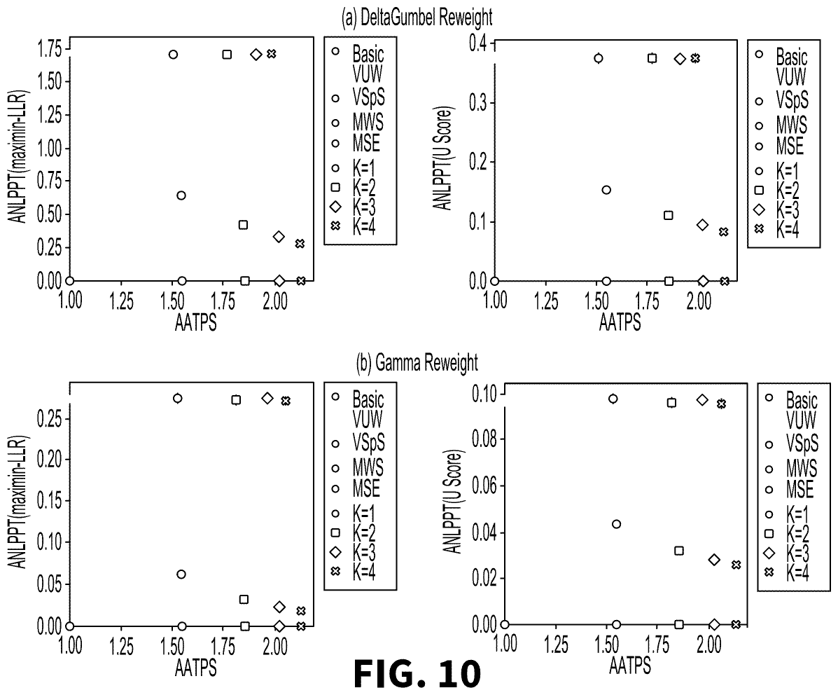

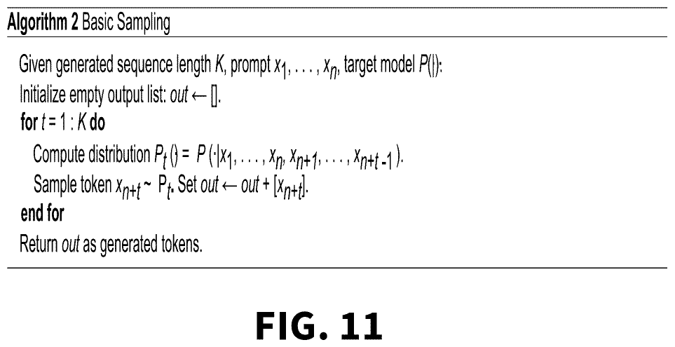

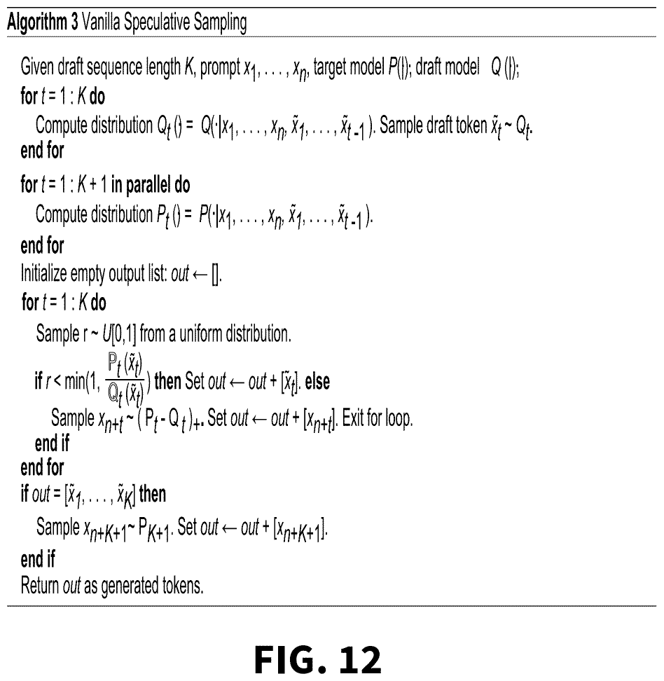

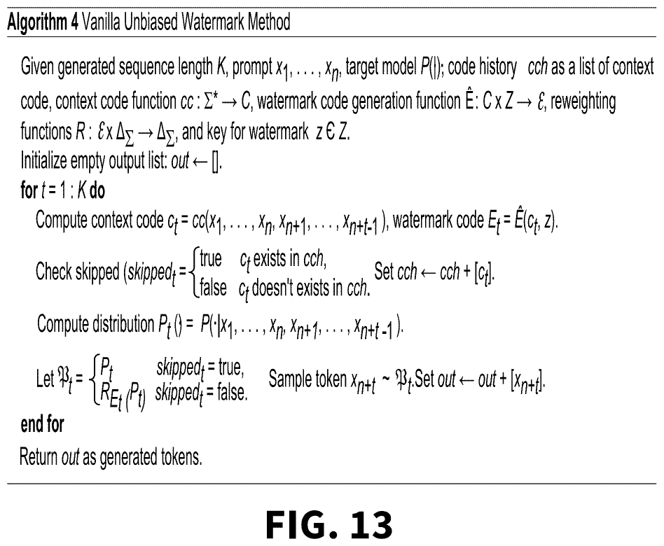

FIG. 10 illustrates results of a comparison of the performance of basic sampling (FIG. 11; Algorithm 2), vanilla speculative sampling (VSpS) (FIG. 12; Algorithm 3), vanilla unbiased watermark (VUW) (FIG. 13; Algorithm 4), maintain watermark strength (MWS), and Maintain Sampling Efficiency (MSE). As illustrated in FIG. 10, the x-axis shows the Average Accepted Tokens Per Step (AATPS) as a measure of speculative sampling efficiency, while the y-axis shows the Average Negative Log P-value Per Token (ANLPPT) as a measure of watermark strength. The P-value may be determined based on either a likelihood-based test using the maximin-LLR score (left) or a likelihood-agnostic test using the U score (right). According to certain embodiments, the watermarking may be performed using either the DeltaGumbel reweight (top) or the Gamma reweight (bottom), and the error bars represent 3σ confidence intervals.

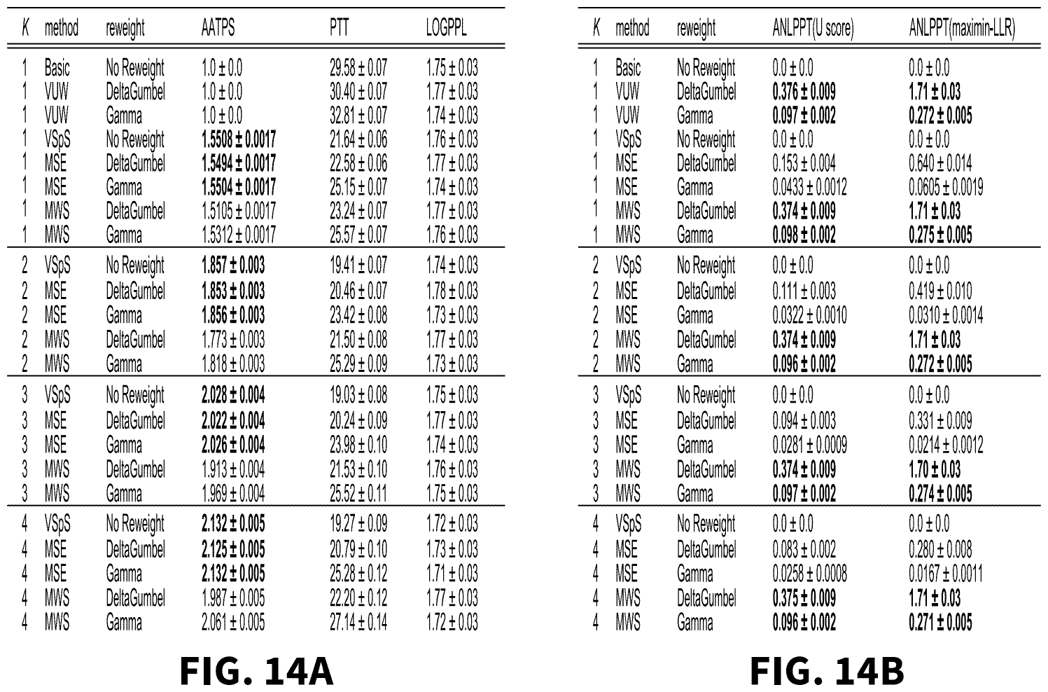

In certain embodiments, the Per Token Time (PTT) in milliseconds may be measured to evaluate the wall-time latency and verify that Algorithm 1 can achieve acceleration compared to the vanilla unbiased watermark method. In some embodiments, the Log Perplexity (LOGPPL) may be determined to verify that all algorithms produce the same output distribution and do not affect the quality of the language model output. The raw data for the additional metrics are provided in the tables illustrated in FIGS. 14A and 14B.

According to certain embodiments, additional experiments may use different models and tasks. In addition to the Llama-7b model, the Llama-13b model in Touvron et al. (see Hugo Touvron, Thibaut Lavril, Gautier Izacard, Xavier Martinet, Marie-Anne Lachaux, Timothée Lacroix, Baptiste Rozière, Naman Goyal, Eric Hambro, Faisal Azhar, et al. Llama: Open and efficient foundation language models. arXiv preprint arXiv:2302.13971, 2023, the teachings of which are incorporated herein by reference) as the target model, with Llama-68m in Miao as the draft model. Besides the text summarization task, the methods on an open-ended text generation task may also be evaluated. The results of these additional experiments are illustrated in FIGS. 5-7.

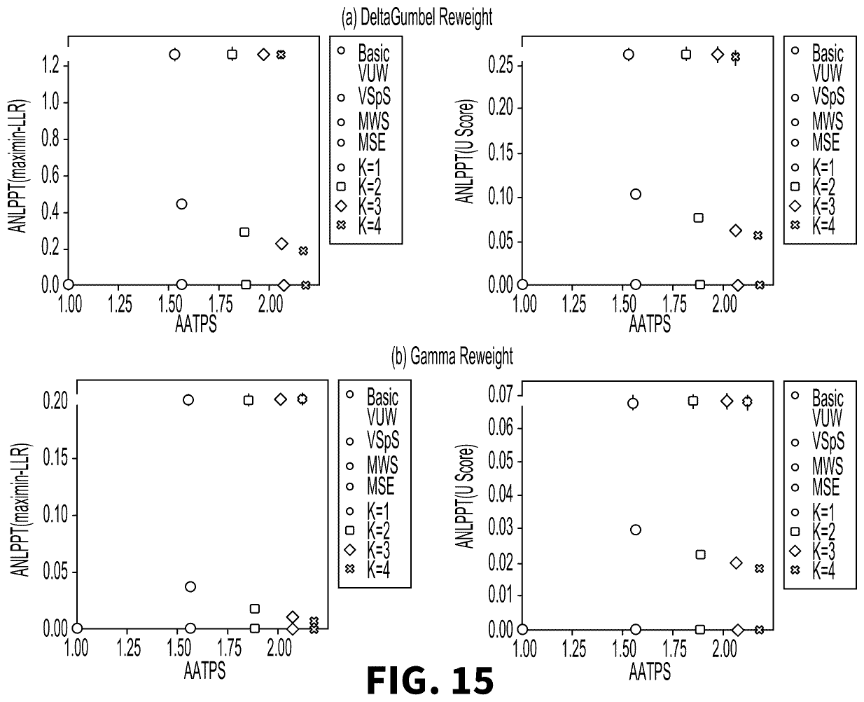

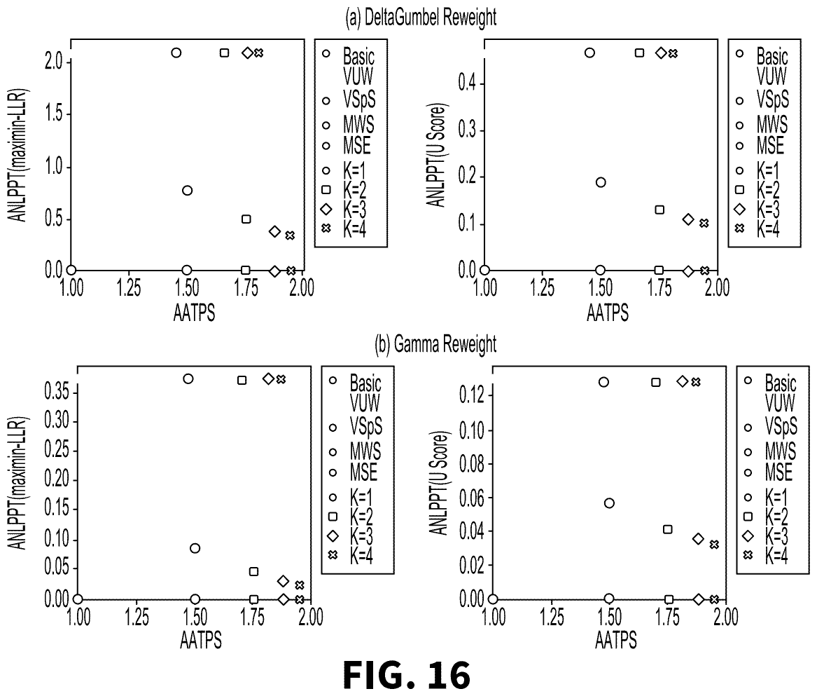

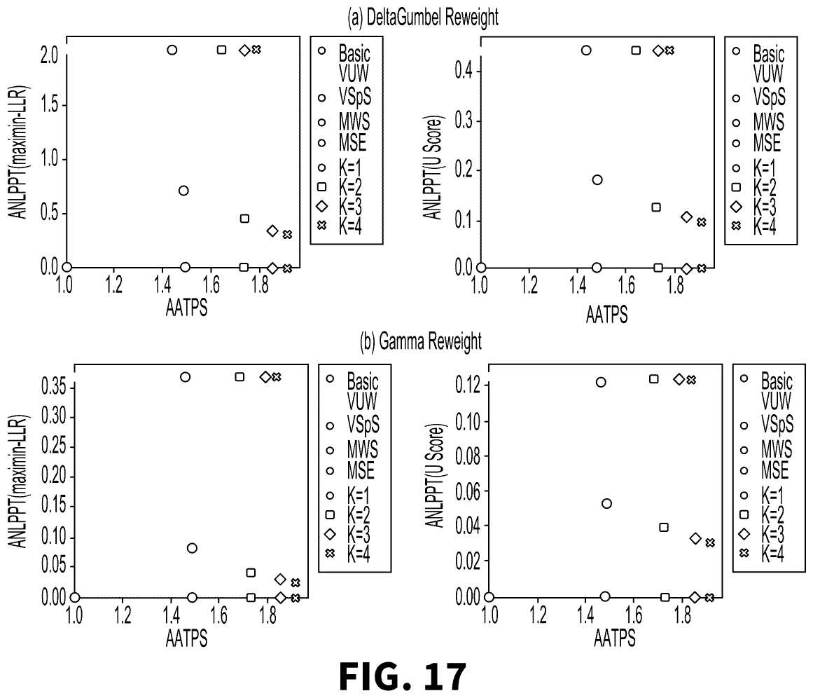

The experimental results illustrated in FIGS. 9 and 15-17 show that Algorithm 1 can maintain either the watermark strength or the sampling efficiency. As illustrated in FIGS. 15-17, the output performance across multiple methods, tasks, and base models are evaluated by varying (i) the reweighting function, and (ii) the number of draft tokens per decoding step. As further illustrated in FIGS. 15-17, two primary metrics are reported including, for example, the average accepted tokens per step (AATPs) and the average negative log p-value per token (ANLPPT). The AATPs measures sampling efficiency where higher AATPs values indicate that more drafted tokens are accepted and less computation is wated. On the other hand, ANLPPT measures watermark strength. For instance, higher ANLPPT values indicate a stronger watermark signal. Additionally, ANLPPT values may depend on the detection method, and both maximin-LLR (likelihood-based) and U-score (likelihood-agnostic) may be reported. Additionally, the MWS method achieves the same sampling efficiency as the VSpS method. FIGS. 9 and 15-17 also show that Algorithm 1 can accelerate the generation process compared to the vanilla unbiased watermark method. Both the MWS and MSE methods achieve lower PTT than the VUW method, as illustrated in FIGS. 14A and 14B. As further illustrated in FIGS. 9 and 15-17, all algorithms produce the same output distribution and do not affect the quality of the language model output, as evidenced by the similar LOGPPL values across all methods in FIGS. 14A and 14B. These findings are consistent across different draft sequence lengths (K=1,2,3,4), different models (Llama-7b and Llama-13b), different tasks (e.g., text summarization and open-ended text generation), different reweight schemes (e.g., DeltaGumbel and Gamma), and different watermark detection methods (e.g., likelihood-based and likelihood agnostic).

In the DeltaGumbel reweight scheme, the watermark code E is a list of |Σ| independent and identically distributed standard Gumbel variables. The reweighting function is defined as:

$${R}_{E} ( P ) := {δ}_{{a}^{*}} , {a}^{*} := arg {max}_{a} \{ log P ( a ) + E ( a ) \} \qquad ( 23 )$$

where δ_{a*} is the Dirac delta function centered at a*. The U score for the DeltaGumbel reweight is defined as:

$$U = exp ( - exp ( - E ( x ) ) ) ∈ [ 0 , 1 ] , \qquad ( 24 )$$

If there is no watermark added while generating x, in other words, if the token x is independent with E, then the random U is uniformly distributed in [0, 1]. Additionally, the logarithm of the moment-generating function (MGF) of the U score for the DeltaGumbel reweight is given by:

$$log 𝔼 [ exp ( λ U ) ] = - log ( λ ) + log ( {e}^{λ} - 1 ) . \qquad ( 25 )$$

In the Gamma reweight scheme, the watermark code E is a random bijection from E to the set {0, 1, 2, . . . , |Σ|−1}. The reweighting function is defined as:

$${R}_{E} ( P ) ( t ) := {A}_{EP} ( E ( t ) ) - {A}_{EP} ( E ( t ) - 1 ) , \qquad ( 26 )$$

$${A}_{EP} ( i ) := max \{ 2 ( {\sum }_{a ∈ \sum } 1 ( E ( a ) \leq i ) P ( a ) ) - 1 , 0 \} . \qquad ( 27 )$$

The U score for the Gamma reweight is defined as:

$$U = \frac{E ( x ) + \frac{1}{2}}{\vert \sum \vert} ∈ [ 0 , 1 ] . \qquad ( 28 )$$

If there is no watermark added while generating x, in other words, if the token x is independent with E, then the random U is uniformly distribution in

$$\{ \frac{\frac{3}{2}}{\vert \sum \vert} ′ \frac{\frac{3}{2}}{\vert \sum \vert} , … , \frac{\vert \sum \vert - \frac{1}{2}}{\vert \sum \vert} \} .$$

The logarithm of the moment-generating function (MGF) of the U score for the Gamma reweight is given by:

$$log 𝔼 [ exp ( λ U ) ] = - log ( 2 \vert \sum \vert sinh ( \frac{λ}{2 \vert \sum \vert} ) ) + log ( {e}^{λ} - 1 ) . \qquad ( 29 )$$

Both the DeltaGumbel reweight and Gamma reweight schemes are unbiased, meaning that for any distribution P∈Δ_{Σ}, the following is obtained:

$${𝔼}_{E ∼ {P}_{E}} [ {R}_{E} ( P ) ] = P . \qquad ( 30 )$$

The U scores defined for these reweight schemes are likelihood-agnostic, which means that they do not depend on the original distribution P. This property makes them possibly more robust to perturbations compared to likelihood-based scores such as the LLR score. To determine the P-value for detecting watermarks using the U score, the corresponding MGF may be substituted into Equation (1).

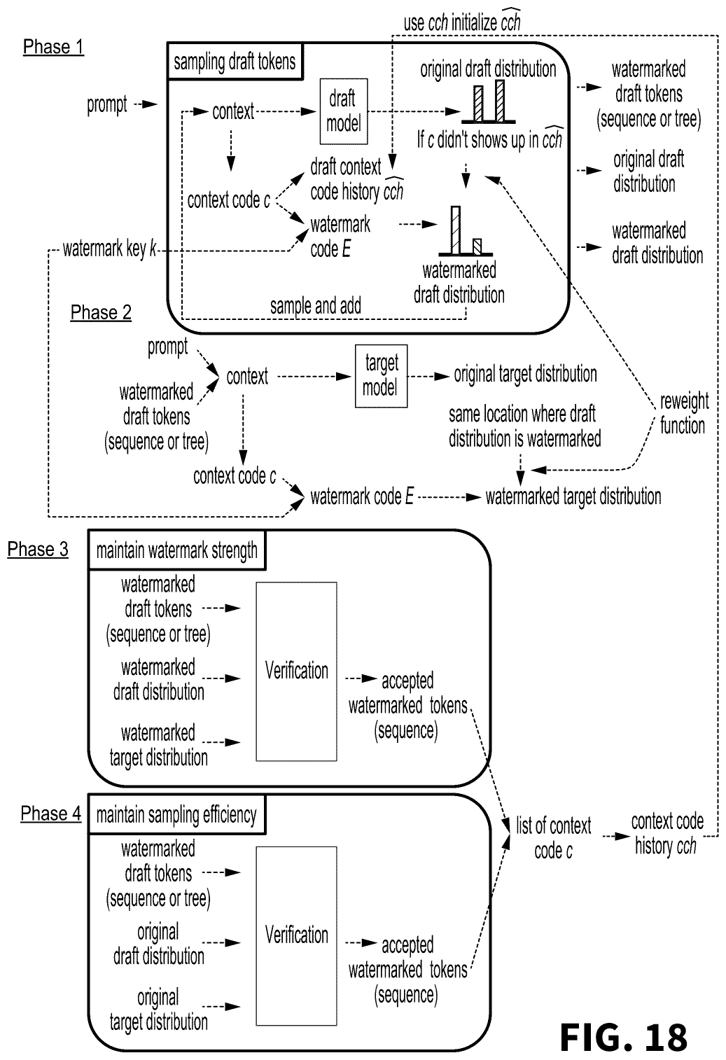

FIG. 18 illustrates an example token generation flow, according to certain embodiments. In phase 1, the flow is initiated when a prompt is received by a user. Once initiated, a context (e.g., sentence) is fed into the draft model to generate an original draft distribution of draft tokens conditioned on the context. Phase 1 also includes extracting a context code c from the context, where the context code c represents a summary of the context or one or more of the last few tokens from the context. The context code c is combined (e.g., via a hash function) with a watermark key k to extract a watermark code E. In certain embodiments, when generating multiple draft tokens in sequence, earlier tokens may influence the watermark code E used for later tokens. According to certain embodiments, the watermarked draft tokens may be presented, depending on the speculated sampling method used, as a sequence of tokens or a tree model that includes a root token and multiple tokens that follow the root token. Additionally, in phase 1, a reweight function is applied with the original draft distribution and the watermark code E as input to obtain a watermarked draft distribution.

As illustrated in FIG. 18, in phase 2, a prompt (which may be different from the prompt in phase 1) and the watermarked draft tokens obtain from phase 1 are combined to generate the context. The context is fed to the target model, which generates an original target distribution. In phase 2, a context code c is extracted from the context, and combined, via a hash function, with the watermark key k to obtain the watermark code E. In certain embodiments, the watermark code E in phase 1 and phase 2 may be the same. As further illustrated in FIG. 18, in phase 2, the same reweight function applied in phase 1 is applied in phase 2 to generate the watermarked target distribution. To obtain the watermarked target distribution, the original target distribution and the watermark code E serve as input for the reweight function, and the watermark code E in phase 2 may be the same as the watermark code E in phase 1. According to certain embodiments, the watermarked draft distribution and the watermarked target distribution are unbiased. With unbiased distributions, it may be possible to preserve their quality. For instance, by averaging over both a random watermark key and the randomness from the verification process, the expected output distribution may match the original (unwatermarked) target model's distribution. Thus, the watermark is unbiased and does not change the output quality in expectation. Further, in maintaining watermark strength, averaging over the verifier's randomness, the expected output distribution matches the watermarked target model's distribution, for any watermark key.

As illustrated in FIG. 18, phase 3 represents maintaining the watermark strength of the tokens which includes a verification step. For example, verification may be performed by taking the ratio of the watermarked draft distribution and the watermarked target distribution, where each token of the watermarked draft distribution and watermarked target distribution are assigned a confidence value (e.g., probability). During verification, if P(x)/Q(x)≥1, accept x deterministically, and if P(x)/Q(x)<1, accept x with probability r (e.g., a uniform random variable between 0 and 1), otherwise reject x. If x is rejected, a replacement token y is drawn from the residual distribution proportional to max (P(y)−Q(y), 0). Other embodiments may include more advanced variants (e.g. tree verification), but they may follow the same core idea of comparing P and Q, and using acceptance plus residual sampling to match P.

According to certain embodiments, verification may check to see if the tokens from the draft model are the same as what the target model would have also produced given a certain context. According to certain embodiments, if the confidence value of each of the tokens in the watermarked target distribution is greater than or equal to the confidence value of each of a corresponding token in the watermarked draft distribution, then the watermarked draft token is accepted, otherwise, the watermarked draft token is rejected. On the other hand, if the confidence value of each of the tokens in the watermarked target distribution is less than the confidence value of each of a corresponding token in the watermarked draft distribution, then the watermarked draft token is accepted by a certain probability based on the confidence value of the watermarked draft token and the watermarked target token. For example, if the confidence value of the watermarked draft token is 0.8 and the confidence value of the watermarked target token is 0.4, the watermarked draft token may have an acceptance probability of 0.5 (50%).

After verification, a sequence of accepted watermarked tokens is generated, and later forms a list of context codes c. The list of context code c may be saved as context code history, which may be fed back into phase 1 to ensure that the same context code key is not used twice, and to ensure that the entire generation process is unbiased.

In phase 4, the verification procedure may be similar to that of phase 3 except the input for the verification in phase 4 utilizes the original draft distribution and the original target distribution. Further, in some embodiments, in maintaining sampling efficiency, the same watermark code E may be used for both target and draft reweighting. In other embodiments, a single watermark key k may be used for both the draft model and target model.

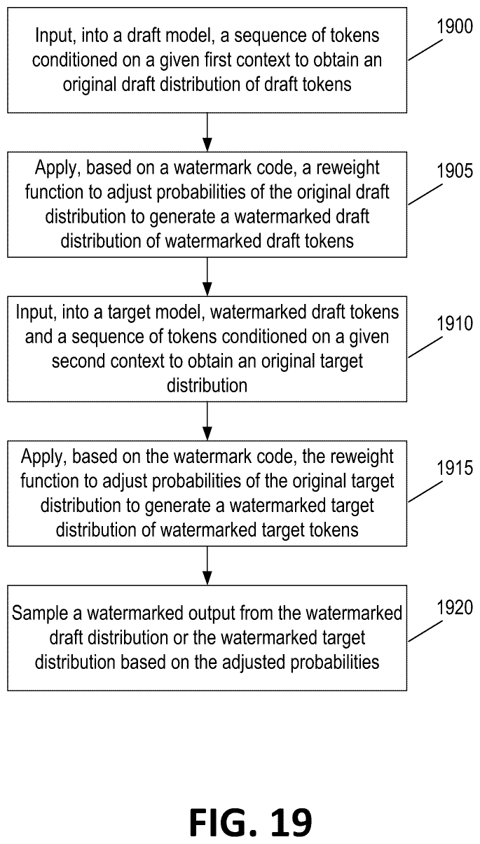

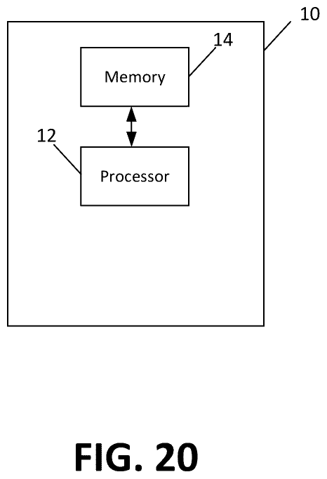

FIG. 19 illustrates an example flow diagram of a method, according to certain example embodiments. In an example embodiment, the method of FIG. 19 may be performed by a system that includes a computer apparatus, computer system, network, neural network, apparatus, or other similar device(s). According to certain embodiments, each of these apparatuses of the system may be represented by, for example, an apparatus similar to apparatus 10 illustrated in FIG. 20.

As illustrated in FIG. 19, the method may include, at 1900, inputting, into a draft model, a sequence of tokens conditioned on a given first context to obtain an original draft distribution of draft tokens. The method may also include, at 1905, applying, based on a watermark code, a reweight function to adjust probabilities of the original draft distribution to generate a watermarked draft distribution of watermarked draft tokens. The method may further include, at 1910, inputting, into a target model, watermarked draft tokens and a sequence of tokens conditioned on a given second context to obtain an original target distribution. In addition, the method may include, at 1915, applying, based on the watermark code, the reweight function to adjust probabilities of the original target distribution to generate a watermarked target distribution of watermarked target tokens. Further, the method may include, at 1920, sampling a watermarked output from the watermarked draft distribution or the watermarked target distribution based on the adjusted probabilities.

According to certain embodiments, the method may also include verifying the watermarked draft distribution by sampling at least one watermarked draft token, and inputting the at least one sampled watermarked draft token into the watermarked target distribution. According to some embodiments, the verification may include rejecting or accepting the at least one watermarked draft token based whether a confidence level of the at least one watermarked draft token satisfied a predefined threshold of the watermarked target distribution. According to other embodiments, the method may also include performing speculative sampling on the watermarked draft distribution to generate sequences of watermarked draft tokens having a predefined length.

In certain embodiments, the original draft distribution may match the watermarked draft distribution, or the original watermarked target distribution may match the watermarked target distribution. In some embodiments, the method may also include obtaining a sample of watermarked draft tokens by sampling the watermarked draft model distribution, and correcting the sample of watermarked draft tokens based on the original target distribution. In certain embodiments, the correction may be performed by using the target model to resample a next best token option of the underlying distribution of rejected tokens, In other embodiments, the method may further include measuring a watermarking strength of the watermarked draft distribution or the watermarked target distribution based on an acceptance and rejection rate of the watermarked draft tokens and the watermarked target tokens.

Although only one apparatus is illustrated in FIG. 20, the apparatus may represent multiple apparatus as part of a system or network. For example, in certain embodiments, apparatus 10 may be a computer apparatus that operate individually or together as a system.

In some embodiments, the functionality of any of the methods, processes, algorithms or flow charts described herein may be implemented by software and/or computer program code or portions of code stored in memory or other computer readable or tangible media, and executed by a processor.

For example, in some embodiments, apparatus 10 may include one or more processors, one or more computer-readable storage medium (for example, memory, storage, or the like), one or more radio access components (for example, a modem, a transceiver, or the like), and/or a user interface. It should be noted that one of ordinary skill in the art would understand that apparatus 10 may include components or features not shown in FIG. 19, and other embodiments may include multiple apparatuses similar to apparatus 10 that are interconnected via a network or are connected to each other either wireless and/or wired connections.

As illustrated in the example of FIG. 20, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 20, multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-19.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-19.

Additionally or alternatively, in some embodiments, apparatus 10 may include an input and/or output device (I/O device). In certain embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, processor 12 and memory 14 may be included in or may form a part of processing circuitry or control circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware.

For instance, in certain example embodiments, apparatus 10 may be controlled by memory 14 and processor 12 to input, into a draft model, a sequence of tokens conditioned on a given first context to obtain an original draft distribution of draft tokens. Apparatus 10 may also be controlled by memory 14 and processor 12 to apply, based on a watermark code, a reweight function to adjust probabilities of the original draft distribution to generate a watermarked draft distribution of watermarked draft tokens. Apparatus 10 may further be controlled by memory 14 and processor 12 to input, into a target model, watermarked draft tokens and a sequence of tokens conditioned on a given second context to obtain an original target distribution. In addition, apparatus 10 may be controlled by memory 14 and processor 12 to apply, based on the watermark code, the reweight function to adjust probabilities of the original target distribution to generate a watermarked target distribution of watermarked target tokens. Further, apparatus 10 may be controlled by memory 14 and processor 12 to sample a watermarked output from the watermarked draft distribution or the watermarked target distribution based on the adjusted probabilities.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for inputting, into a draft model, a sequence of tokens conditioned on a given first context to obtain an original draft distribution of draft tokens. The apparatus may also include means for applying, based on a watermark code, a reweight function to adjust probabilities of the original draft distribution to generate a watermarked draft distribution of watermarked draft tokens. The apparatus may further include means for inputting, into a target model, watermarked draft tokens and a sequence of tokens conditioned on a given second context to obtain an original target distribution. In addition, the apparatus may include means for applying, based on the watermark code, the reweight function to adjust probabilities of the original target distribution to generate a watermarked target distribution of watermarked target tokens. Further, the apparatus may include means for sampling a watermarked output from the watermarked draft distribution or the watermarked target distribution based on the adjusted probabilities.

Certain example embodiments described herein provide several technical improvements, enhancements, and/or advantages. For instance, in some example embodiments, it may be possible to extend the approaches described herein to other speculative sampling techniques including, for example, tree verification. In other embodiments, it may be possible to provide a rigorous theoretical founding for understanding the trade-off between watermark strength and sampling efficiency in the context of accelerated generation of watermarked tokens from the LLMs. Certain embodiments also prove a no-go theorem, showing that the non-trivial trade-offs are inevitable when the vocabulary size is greater than two. Other embodiments provide algorithms that prioritize either watermark strength or sampling efficiency, and provide methods for protecting LLMs while leveraging the efficiency of speculative sampling techniques. In other embodiments, it may be possible to accelerate the generation sped of existing watermarking methods for LLMs.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example.

Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware or circuitry included in an apparatus (e.g., apparatus 10), for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an example embodiment, an apparatus, such as a device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

### Partial Glossary

AI Artificial Intelligence
API Application Programming Interface
LLM Large Language Model
LM Language Model
MT Machine Translation
TS Text Summarization

We claim:

1. A method of generating tokens in a large language model (LLM), comprising:
inputting, into a draft model, a sequence of tokens conditioned on a given first context to obtain an original draft distribution of draft tokens;
applying, based on a watermark code, a reweight function to adjust probabilities of the original draft distribution to generate a watermarked draft distribution of watermarked draft tokens;
inputting, into a target model, watermarked draft tokens and a sequence of tokens conditioned on a given second context to obtain an original target distribution;
applying, based on the watermark code, the reweight function to adjust probabilities of the original target distribution to generate a watermarked target distribution of watermarked target tokens; and
sampling a watermarked output from the watermarked draft distribution or the watermarked target distribution based on the adjusted probabilities.

2. The method according to claim 1, further comprising:
verifying the watermarked draft distribution by sampling at least one watermarked draft token, and inputting the at least one sampled watermarked draft token into the watermarked target distribution.

3. The method according to claim 2, wherein the verification comprises:
rejecting or accepting the at least one watermarked draft token based whether a confidence level of the at least one watermarked draft token satisfied a predefined threshold of the watermarked target distribution.

4. The method according to claim 1, further comprising:
performing speculative sampling on the watermarked draft distribution to generate sequences of watermarked draft tokens having a predefined length.

5. The method according to claim 1,
wherein the original draft distribution matches the watermarked draft distribution, or
wherein the original watermarked target distribution matches the watermarked target distribution.

6. The method according to claim 1, further comprising:
obtaining a sample of watermarked draft tokens by sampling the watermarked draft model distribution; and
correcting the sample of watermarked draft tokens based on the original target distribution.

7. The method according to claim 1, further comprising:
measuring a watermarking strength of the watermarked draft distribution or the watermarked target distribution based on an acceptance and rejection rate of the watermarked draft tokens and the watermarked target tokens.

8. An apparatus for generating tokens in a large language model (LLM), comprising:
at least one processor; and
at least one memory including computer program code which, when executed by the at least one processor, cause the apparatus to at least:
input, into a draft model, a sequence of tokens conditioned on a given first context to obtain an original draft distribution of draft tokens;
apply, based on a watermark code, a reweight function to adjust probabilities of the original draft distribution to generate a watermarked draft distribution of watermarked draft tokens;
input, into a target model, watermarked draft tokens and a sequence of tokens conditioned on a given second context to obtain an original target distribution;
apply, based on the watermark code, the reweight function to adjust probabilities of the original target distribution to generate a watermarked target distribution of watermarked target tokens; and
sample a watermarked output from the watermarked draft distribution or the watermarked target distribution based on the adjusted probabilities.

9. The apparatus according to claim 8, wherein the at least one memory storing the instructions, when executed by the at least one processor, further cause the apparatus at least to:
verify the watermarked draft distribution by sampling at least one watermarked draft token, and inputting the at least one sampled watermarked draft token into the watermarked target distribution.

10. The apparatus according to claim 9, wherein the verification comprises:
rejecting or accepting the at least one watermarked draft token based whether a confidence level of the at least one watermarked draft token satisfied a predefined threshold of the watermarked target distribution.

11. The apparatus according to claim 8, wherein the at least one memory storing the instructions, when executed by the at least one processor, further cause the apparatus at least to:
perform speculative sampling on the watermarked draft distribution to generate sequences of watermarked draft tokens having a predefined length.

12. The apparatus according to claim 8,
wherein the original draft distribution matches the watermarked draft distribution, or
wherein the original watermarked target distribution matches the watermarked target distribution.

13. The apparatus according to claim 8, wherein the at least one memory storing the instructions, when executed by the at least one processor, further cause the apparatus at least to:
obtain a sample of watermarked draft tokens by sampling the watermarked draft model distribution; and
correct the sample of watermarked draft tokens based on the original target distribution.

14. The apparatus according to claim 8, wherein the at least one memory storing the instructions, when executed by the at least one processor, further cause the apparatus at least to:
measure a watermarking strength of the watermarked draft distribution or the watermarked target distribution based on an acceptance and rejection rate of the watermarked draft tokens and the watermarked target tokens.

15. A non-transitory computer readable medium encoded with instructions that, when executed in hardware, perform a process, the process comprising:
inputting, into a draft model, a sequence of tokens conditioned on a given first context to obtain an original draft distribution of draft tokens;
applying, based on a watermark code, a reweight function to adjust probabilities of the original draft distribution to generate a watermarked draft distribution of watermarked draft tokens;
inputting, into a target model, watermarked draft tokens and a sequence of tokens conditioned on a given second context to obtain an original target distribution;
applying, based on the watermark code, the reweight function to adjust probabilities of the original target distribution to generate a watermarked target distribution of watermarked target tokens; and
sampling a watermarked output from the watermarked draft distribution or the watermarked target distribution based on the adjusted probabilities.

16. The non-transitory computer readable medium according to claim 15, wherein the process further comprises:
verifying the watermarked draft distribution by sampling at least one watermarked draft token, and inputting the at least one sampled watermarked draft token into the watermarked target distribution.

17. The non-transitory computer readable medium according to claim 16, wherein the verification comprises:
rejecting or accepting the at least one watermarked draft token based whether a confidence level of the at least one watermarked draft token satisfied a predefined threshold of the watermarked target distribution.

18. The non-transitory computer readable medium according to claim 15, wherein the process further comprises:
performing speculative sampling on the watermarked draft distribution to generate sequences of watermarked draft tokens having a predefined length.

19. The non-transitory computer readable medium according to claim 15,
wherein the original draft distribution matches the watermarked draft distribution, or
wherein the original watermarked target distribution matches the watermarked target distribution.

20. The non-transitory computer readable medium according to claim 15, wherein the process further comprises:
obtaining a sample of watermarked draft tokens by sampling the watermarked draft model distribution; and
correcting the sample of watermarked draft tokens based on the original target distribution.
